(19) United States
(12) Patent Application Publication
(10) Pub. No.: US 2026/0154647 A1
(43) Pub. Date: Jun. 4, 2026

(54) SYSTEMS, PROCESSORS, AND METHODS FOR MANAGING PRODUCTIVITY OF ONE OR MORE USERS

(71) Applicant: DBS Bank Ltd, Singapore (SG)

(72) Inventors: Anil Kumar SAHA, Singapore (SG); Bryan Ting Hao SEE TOW, Singapore (SG); Yi Qiang SNG, Singapore (SG); Koon Seng LIM, Singapore (SG)

(73) Assignee: DBS Bank Ltd, Singapore (SG)

(21) Appl. No.: 18/714,599

(22) PCT Filed: Sep. 12, 2023
(86) PCT No.: PCT/SG2023/050615

§ 371 Date: May 30, 2024

(51) Int. Cl. G06Q 10/0639

(52) U.S. Cl. CPC G06Q 10/06393

(57) ABSTRACT

Embodiments relate to methods and systems for managing productivity. The method includes a setup process, including identifying team information. The setup process includes generating positive and negative set of metrics. The method includes performing a productivity assessment process, including obtaining a productivity value for each metric. The productivity assessment process includes performing a uniformity process, including selecting positive maximum and positive minimum values for each metric in the positive set of metrics; and selecting negative maximum and negative minimum values for each in the negative set of metrics. Positive and negative metric scores are determined. The method includes generating one or more productivity scores for each individual or the team.

### TECHNICAL FIELD

The present disclosure relates generally to systems, processors, and methods for managing productivity of one or more individuals and/or a team. More specifically, present example embodiments relate to systems, processors, and methods for measuring, among other things, productivity and productivity trends for users.

### BACKGROUND

Conventionally, productivity measurements for employees, including those who are developer(s) and/or a team of developers, have been primarily performed via surveys and/or other subjective evaluations, the results of which are generally unable to provide overall quantitative insights into, measurements of, and/or comparisons of, among other things, productivity and/or performance of the employees.

### SUMMARY

In terms of conventional approaches to measuring productivity of employees, including those who are developer(s) and/or a team of developers, the general focus has been the use of surveys, questionnaires, checklists, and/or other subjective evaluations. Such approaches have generally been unable to provide accurate or measurable insights into, and/or comparisons of productivity and/or performance of the employees. Recently, there have been various attempts made to solve the aforementioned problems. For example, systems and methods have been put forward that focus on obtaining measurement data for tasks completed over time for the purposes of performance evaluation and/or review. However, such systems and methods still involve subjective evaluations such as user-populated information or inputs on qualitative factors, work environment, and/or user-determined limits.

With advances in technology, we are seeing a multitude of technologies and platforms that measure productivity by focusing primarily on subjective evaluations, task completion statuses, etc. which makes it difficult for users to have an adequate overview of quantitative productivity metrics and glean respective areas of strength and/or weakness.

Present example embodiments relate generally to and/or include systems, subsystems, processors, devices, logic, methods, and processes for addressing conventional problems, including those described above and in the present disclosure, and more specifically, example embodiments relate to systems, subsystems, processors, devices, logic, methods, and processes for generating, among other things, productivity scores, productivity trends, and productivity recommendations for users.

In an exemplary embodiment, a method for managing productivity of a team, the method comprising performing, by a processor, a setup process. The setup process includes identifying, by the processor, team information, the team information being information pertaining to the team. The method includes generating, by the processor, a positive set of metrics, the positive set of metrics including a first quantity of quantifiable productivity metrics, each metric in the positive set of metrics being a metric in which higher values represent better results, each metric in the positive set of metrics selected based on at least the team information. The method includes generating, by the processor, a negative set of metrics, the negative set of metrics including a second quantity of quantifiable productivity metrics, each metric in the negative set of metrics being a metric in which lower values represent better results, each metric in the negative set of metrics selected based on at least the team information. The method also includes selecting, by the processor, a productivity assessment time period.

Once the setup process is completed, the method for managing productivity of a team further includes performing, by the processor, a productivity assessment process for the team. The productivity assessment process for the team includes obtaining, for the team for the productivity assessment time period, a productivity value for each metric in the positive set of metrics. The method also includes obtaining, for the team for the productivity assessment time period, a productivity value for each metric in the negative set of metrics.

Next, the method includes performing a uniformity process. The uniformity process includes selecting, for the team, a positive maximum value for each metric in the positive set of metrics, the positive maximum value for each metric in the positive set of metrics being a maximum value for the metric and selecting, for the team, a positive minimum value for each metric in the positive set of metrics, the positive minimum value for each metric in the positive set of metrics being a minimum value for the metric.

With the negative set of metrics, the uniformity process includes selecting, for the team, a negative maximum value for each metric in the negative set of metrics, the negative maximum value for each metric in the negative set of metrics being a maximum value for the metric, and selecting, for the team, a negative minimum value for each metric in the negative set of metrics, the negative minimum value for each metric in the negative set of metrics being a minimum value for the metric. For each metric in the positive set of metrics, generating a positive metric score for the metric in the positive set of metrics, each positive metric score for the metric in the positive set of metrics generated based on the obtained productivity value for the metric in the positive set of metrics and the selected positive maximum value; and for each metric in the negative set of metrics, generating a negative metric score for the metric in the negative set of metrics, each negative metric score for the metric in the negative set of metrics generated based on the obtained productivity value for the metric in the negative set of metrics and the selected negative maximum value.

The method for performing a productivity assessment process includes performing a first centroid generation process. The first centroid generation process includes plotting, on a radar chart for each metric in the positive set of metrics, the generated positive metric score for the metric in the positive set of metrics; and plotting, on the radar chart for each metric in the negative set of metrics, the generated negative metric score for the metric in the negative set of metrics. The first centroid generation process also includes generating, on the radar chart, a first resultant shape, the first resultant shape generated by connecting all generated positive metric scores plotted in the radar chart and all generated negative metric scores plotted in the radar chart. The first centroid generation process further includes plotting, on the radar chart, an overall centroid value for the first resultant shape, the overall centroid value for the first resultant shape being a centroid for the first resultant shape.

The method for performing a productivity assessment process includes performing a second centroid generation process. The second centroid generation process including plotting, on the radar chart for each metric in the positive set of metrics, the selected positive maximum value for the metric in the positive set of metrics; and plotting, on the radar chart for each metric in the negative set of metrics, the selected negative minimum value for the metric in the negative set of metrics. The second centroid generation process includes generating, on the radar chart, a second resultant shape, the second resultant shape generated by connecting all selected positive maximum values plotted in the radar chart and all selected negative minimum values plotted in the radar chart. The second centroid generation process further includes plotting, on the radar chart, a maximum centroid value for the second resultant shape, the maximum centroid value for the second resultant shape being a centroid for the second resultant shape.

The method for performing a productivity assessment process includes performing a third centroid generation process. The third centroid generation process includes plotting, on the radar chart for each metric in the positive set of metrics, the selected positive minimum value for the metric in the positive set of metrics; and plotting, on the radar chart for each metric in the negative set of metrics, the selected negative maximum value for the metric in the negative set of metrics. The third centroid generation process includes generating, on the radar chart, a third resultant shape, the third resultant shape generated by connecting all selected positive minimum values plotted in the radar chart and all selected negative maximum values plotted in the radar chart. The third centroid generation process further includes plotting, on the radar chart, a minimum centroid value for the third resultant shape, the minimum centroid value for the third resultant shape being a centroid for the third resultant shape.

The method for performing a productivity assessment also includes generating a productivity score for the team. The productivity score generated based on at least a first distance, the first distance being a distance from the overall centroid value for the first resultant shape and the maximum centroid value for the second resultant shape; and a second distance, the second distance being a distance from the maximum centroid value for the second resultant shape and the minimum centroid value for the third resultant shape.

The method for performing a productivity assessment may further includes generating a recommendation to improve productivity of the team. The recommendation to improve productivity of the team may be generated based on, for each metric in the positive set of metrics, forming a first line between the overall centroid value and the maximum centroid value, forming a second line between the overall centroid value and a positive maximum value for the metric, and identifying a first angle formed between the first and second lines; and for each metric in the negative set of metrics, forming a third line between the overall centroid value and the minimum centroid value, forming a fourth line between the overall centroid value and a negative minimum value for the metric, and identifying a second angle formed between the third and fourth lines.

### BRIEF DESCRIPTION OF THE FIGURES

For a more complete understanding of the present disclosure, example embodiments, and their advantages, reference is now made to the following description taken in conjunction with the accompanying figures, in which like reference numbers indicate like features, and:

FIG. 1 is an illustration of an example embodiment of a system for managing productivity of one or more users;

FIG. 2 is an illustration of an example embodiment of a main processor for managing productivity of one or more users;

FIG. 3 is an illustration of an example embodiment of a setup processor;

FIG. 4 is an illustration of an example embodiment of a productivity processor;

FIG. 5 is an illustration of an example embodiment of a method of managing productivity of one or more users;

FIG. 6 is an illustration of an example embodiment of a selection of a positive set of metrics and a selection of a negative set of metrics;

FIG. 7 is an illustration of an example embodiment of a first centroid generation process, including an example embodiment of a radar chart depicting an example of a positive set of metrics, negative set of metrics, generated positive metric scores, generated negative metric scores, and overall centroid value;

FIG. 8 is an illustration of an example embodiment of a second centroid generation process, including an example embodiment of a radar chart depicting an example of a maximum centroid value;

FIG. 9 is an illustration of an example embodiment of a third centroid generation process, including an example embodiment of a radar chart depicting an example of a minimum centroid value;

FIG. 10 is an illustration of an example embodiment of a process of generating a productivity score based on an overall centroid value; and

FIG. 11 is an illustration of an example of a process for generating recommendations on improving productivity.

Although similar reference numbers may be used to refer to similar elements in the figures for convenience, it can be appreciated that each of the various example embodiments may be considered to be distinct variations.

Example embodiments will now be described with reference to the accompanying figures, which form a part of the present disclosure, and which illustrate example embodiments which may be practiced. As used in the present disclosure and the appended claims, the terms “embodiment”, “example embodiment”, “exemplary embodiment”, and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims is for the purpose of describing example embodiments only and is not intended to be limitations. In this respect, as used in the present disclosure and the appended claims, the term “in” may include “in” and “on”, and the terms “a”, “an”, and “the” may include singular and plural references. Furthermore, as used in the present disclosure and the appended claims, the term “by” may also mean “from,” depending on the context. Furthermore, as used in the present disclosure and the appended claims, the term “if” may also mean “when” or “upon”, depending on the context. Furthermore, as used in the present disclosure and the appended claims, the words “and/or” may refer to and encompass any and all possible combinations of one or more of the associated listed items.

### DETAILED DESCRIPTION

Present example embodiments relate generally to and/or include systems, subsystems, processors, devices, logic, methods, and processes for addressing conventional problems with managing productivity of one or more users, individuals, and/or teams, including those described above and in the present disclosure. More specifically, example embodiments relate to systems, subsystems, processors, devices, methods, and processes for managing and/or monitoring productivity of one or more users, individuals, and/or teams, and providing recommendations on improving productivity for one or more individuals and/or team based on the productivity scores/results generated.

As used in the present disclosure, when applicable, the term “user” may also refer to, apply to, and/or include one or more users, one or more user devices of a user, one or more groups of users, one or more teams, one or more businesses, one or more companies, one or more corporations, one or more departments, one or more entities, and/or the like.

As used in the present disclosure, when applicable, the term “productivity” may also refer to, apply to and/or include a measure, status, level, or the like, of a user's efficiency, effectiveness, or the like, to engage in and/or complete the user's assigned work, job, assignment, action, activity, output, story points, codes, project, production, engagement, task, and/or the like.

For example, present example embodiments are configurable or configured to search for, identify, select, compile, generate, transform, process, assess, and/or otherwise receive user data (e.g., for use in an example embodiment of a setup process, as described in the present disclosure). Such user data may include, but is not limited to, personal data of a user (e.g., name, job position, identity, etc.), team information (e.g., identity of each member in the team, team name, number of members in a team, size, position of each member, experience level of each member, experience of each member in working together in the team, seniority, hierarchy, etc.), one or more roles assigned to the team, one or more responsibilities assigned to the team, productivity assessment information (e.g., types of metrics, specific metrics, metrics determination, productivity assessment requirements, productivity assessment periods, etc.), historical information (e.g., historical productivity information, historical metrics determinations, historical productivity assessment period, productivity value for each metric, historical productivity score, historical recommendations on improving productivity for the future, etc.).

Example embodiments are also configurable or configured to search for, identify, select, compile, generate, transform, process, assess, and/or otherwise receive productivity data of a user (e.g., for use in an example embodiment of a productivity assessment process, as described in the present disclosure). Such productivity data may include, but not limited to, productivity metrics, productivity values for one or more productivity metrics, minimum and maximum values for one or more productivity metrics, and productivity scores based on productivity assessment.

Example embodiments are also configurable or configured to search for, identify, compile, generate, transform, process, assess, and/or otherwise suggest recommendations, suggestions, advice, best practices, improvements, or the like, (referred to herein as “recommendations”) for users to improve productivity based on example embodiments of the productivity assessment and/or productivity scores. Such productivity recommendations may include, for example, placing more attention on specific metrics, prioritizing certain tasks and/or operations, automating certain tasks and/or operations, etc.

To perform the actions, functions, processes, and/or methods described above and in the present disclosure, example embodiments include a system (e.g., system 100) for managing productivity. The system 100 may include one or more elements, subsystems, processors, or the like. For example, the system 100 may include one or more processors (e.g., main processor 200). The system 100 may also include one or more databases (e.g., user information database 30). The system 100 may also include one or more productivity management subsystems (e.g., productivity management subsystem 40). The system 100 may also include one or more networks, communication channels, internet, cloud computing, web, private clouds, or the like 50 (referred to herein as “networks”).

Example embodiments will now be described below with reference to the accompanying figures, which form a part of the present disclosure.

### Example Embodiments of a System for Managing Productivity (e.g., System 100).

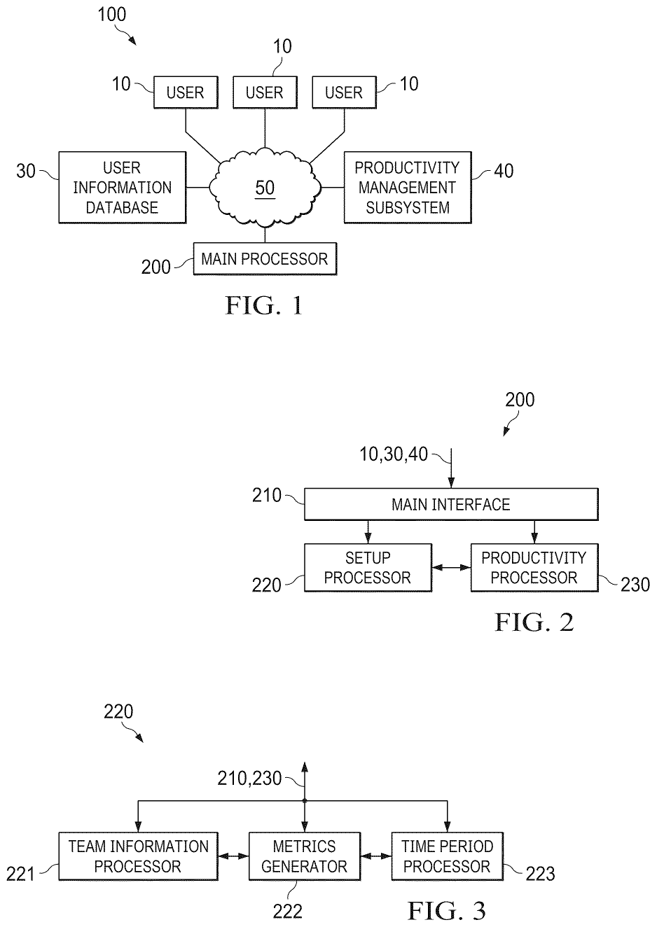

FIG. 1 illustrates an example embodiment of a system (e.g., system 100) for managing productivity for one or more users (e.g., user 10). The system 100 may include, communicate with, and/or manage one or more main processors 200. The system 100 may also include, communicate with, and/or manage one or more user information databases 30, or the like. The system 100 may also include one or more productivity management subsystems 40. The system 100 may also include, communicate with and/or manage one or more networks 50.

The system 100 is configurable or configured to perform one or more of a plurality of functions, operations, actions, methods, and/or processes. For example, as will be further described in the present disclosure, the system 100 is configurable or configured to manage, monitor and/or assess the productivity of one or more users 10. More specifically, the system 100 is configurable or configured to manage, monitor and/or assess the productivity of one or more users 10, individuals 10, teams 10, team members 10, etc. at one or more selected, stipulated, or predetermined time periods (and/or on a continuous basis). The system 100 is also configurable or configured to manage, store, and/or retrieve various information from the user information database 30 to be used by the system 100 to manage productivity of one or more users 10 (and/or teams 10).

The system 100 is also configurable or configured to perform a setup process. An example embodiment of the setup process may include receiving, identifying, and/or selecting one or more information pertaining to one or more users 10 (and/or one or more teams 10) for use by the system 100 in managing productivity.

As will be further described in the present disclosure, the system 100 is also configurable or configured to generate a plurality of metrics for use in measuring productivity of users 10. For example, the system 100 is configurable or configured to generate a positive set of metrics, including a first quantity of quantifiable positive productivity metrics. The system 100 is also configurable or configured to generate a negative set of metrics, including a second quantity of quantifiable negative productivity metrics. As a non-limiting example, a negative metric may be a metric that is opposite to, in contrast with, and/or complementary to one or more positive metrics). The system 100 is also configurable or configured to select one or more time periods in which to perform a productivity assessment (e.g., fixed time periods, variable time periods, adjustable time periods, or continuous in time).

As another example, the system 100 is further configurable or configured to perform a productivity assessment process for users 10. As will be further described in the present disclosure, the system 100 is configurable or configured to obtain a productivity value, score, or the like, for each metric in the positive set of metrics, and to obtain a productivity value, score, or the like, for each metric in the negative set of metrics. The system 100 is also configurable or configured to perform a uniformity process by selecting a positive maximum value, score, or the like, (referred to herein as “selected positive maximum value”) for each metric in the positive set of metrics and selecting a positive minimum value, score, or the like, (referred to herein as “selected positive minimum value”) for each metric in the positive set of metrics. Further, the system 100 is configurable or configured to perform a uniformity process by selecting a negative maximum value, score, or the like, (referred to herein as “selected negative maximum value”) for each metric in the negative set of metrics and selecting a negative minimum value, score, or the like, (referred to herein as “selected negative minimum value”) for each metric in the negative set of metrics. The system 100 also is configurable or configured to generate a positive metric score for each of the metrics in the positive set of metrics and to generate a negative metric score for each of the metrics in the negative set of metrics.

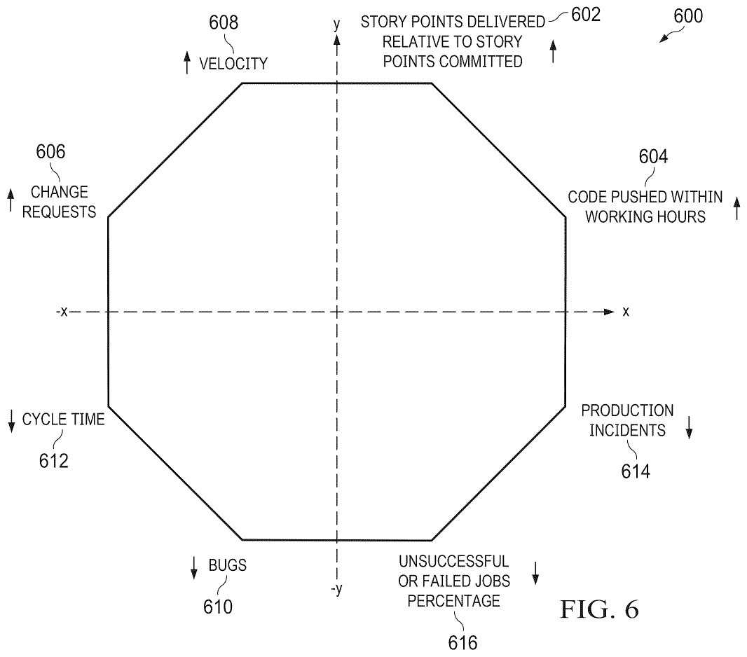

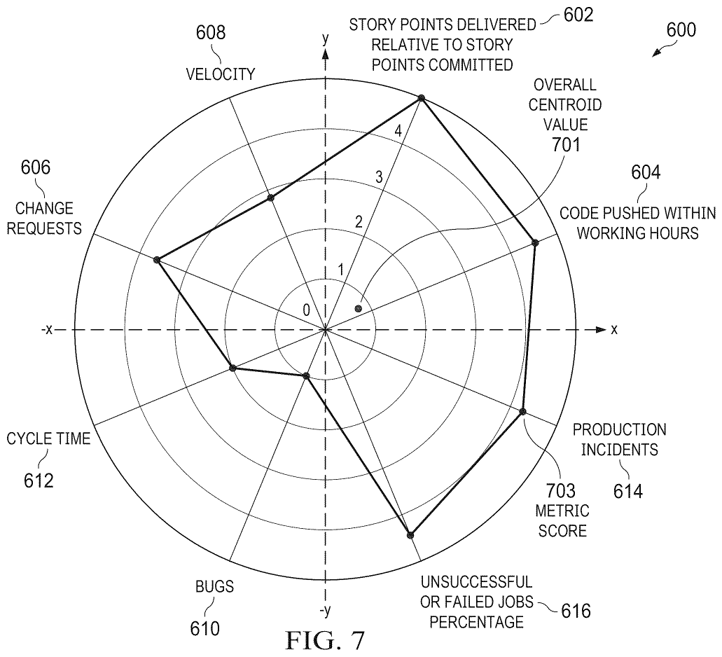

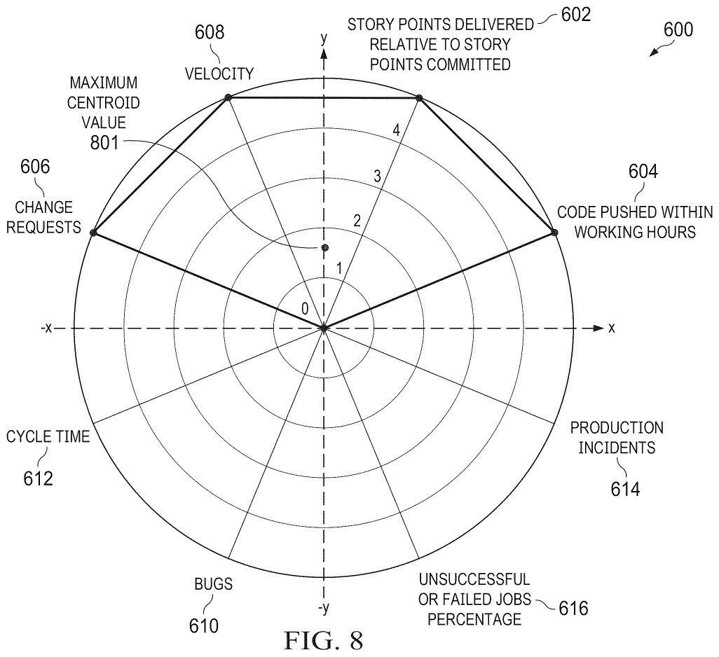

Upon generating such metric scores, the system 100 then performs one or more centroid generation processes. More specifically, the system 100 is configurable or configured to generate a first centroid by plotting, on a radar chart (see, for example, Figures FIGS. 6 and 7) for each metric in the positive set of metrics, the generated positive metric score for the metric in the positive set of metrics, and by plotting, on the same radar chart for each metric in the negative set of metrics, the generated negative metric score for the metric in the negative set of metrics.

Once the positive and negative metric scores are plotted on the radar chart, the system 100 is configurable or configured to generate a first resultant shape on the radar chart. This can be achieved by, for example, connecting all generated positive metric scores plotted in the radar chart (e.g., adjacent plotted generated positive metric scores connected together by a line, curved line, interpolated line, etc.), and connecting all generated negative metric scores plotted in the radar chart (e.g., adjacent plotted generated negative metric scores connected together by a line, curved line, interpolated line, etc.). The system 100 is further configurable or configured to plot an overall centroid value for the first resultant shape on the radar chart (see, for example, FIG. 7), wherein the overall centroid value is a centroid (or the “first centroid”) of the first resultant shape.

In addition to the first centroid, the system 100 is configurable or configured to generate, on a radar chart for each metric in the positive set of metrics, a second centroid by plotting the selected positive maximum value for the metric in the positive set of metrics, and by plotting, on the radar chart for each metric in the negative set of metrics, the selected negative minimum value for the metric in the negative set of metrics.

The system 100 is further configurable or configured to generate a second resultant shape on the radar chart. This can be achieved by, for example, connecting all selected positive maximum values plotted in the radar chart (e.g., adjacent plotted selected positive maximum values connected together by a line, curved line, interpolated line, etc.), and all selected negative minimum values plotted in the radar chart (e.g., adjacent plotted selected negative minimum values connected together by a line, curved line, interpolated line, etc.). The system 100 is further configurable or configured to plot a maximum centroid value for the second resultant shape on the radar chart (see, for example, FIG. 8), wherein the maximum centroid value for the second resultant shape is a centroid (or the “second centroid”) for the second resultant shape.

In addition to the first and second centroids, the system 100 is configurable or configured to generate, on a radar chart for each metric in the positive set of metrics, a third centroid by plotting the selected positive minimum value for the metric in the positive set of metrics, and by plotting, on the radar chart for each metric in the negative set of metrics, the selected negative maximum value for the metric in the negative set of metrics.

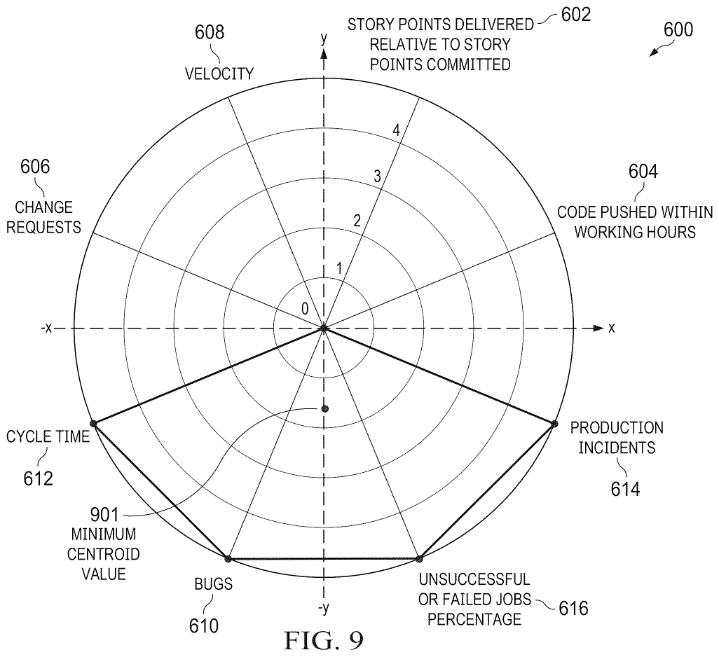

The system 100 is further configurable or configured to generate a third resultant shape on the radar chart. This can be achieved by, for example, connecting all selected positive minimum values plotted in the radar chart (e.g., adjacent plotted selected positive minimum values connected together by a line, curved line, interpolated line, etc.), and all selected negative maximum values plotted in the radar chart (e.g., adjacent plotted selected negative maximum values connected together by a line, curved line, interpolated line, etc.). The system 100 is further configurable or configured to plot a minimum centroid value (see, for example, FIG. 9) for the third resultant shape on the radar chart, wherein the minimum centroid value for the third resultant shape is a centroid (or the “third centroid”) for the third resultant shape.

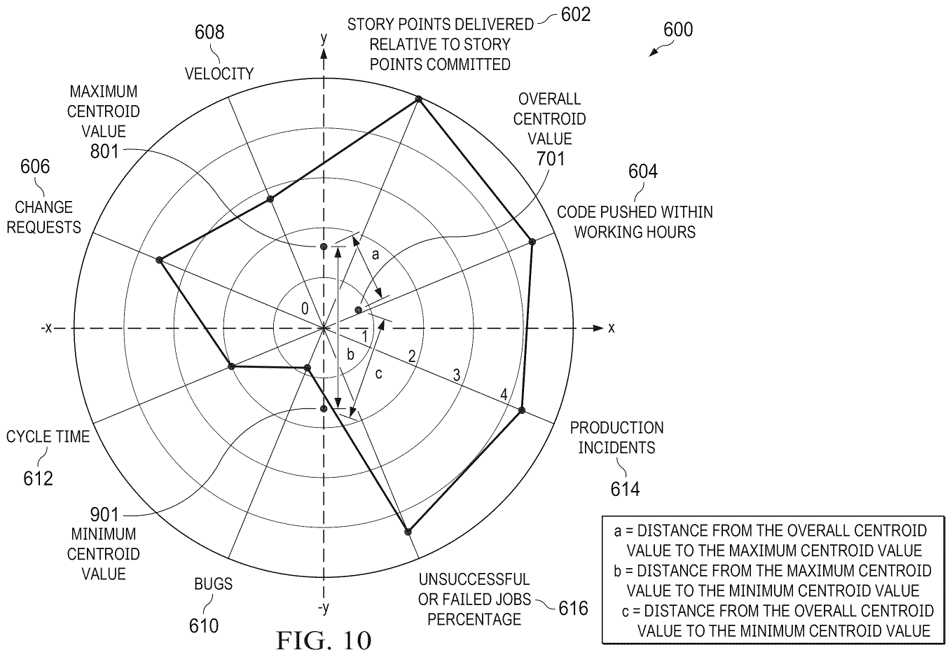

Once the first centroid, the second centroid, and the third centroid are generated, the system 100 is configurable or configured to generate a productivity score for each user 10. The productivity score for each user 10 is generated based on one or more distances from the overall centroid value of the first resultant shape and the maximum centroid value for the second resultant shape, and one or more distances from the maximum centroid value for the second resultant shape and the minimum centroid value for the third resultant shape (see, for example, FIG. 10). Upon generating the productivity score for each user 10, the system 100 is configurable or configured to generate one or more recommendations to improve on productivity for one or more users 10.

It is to be understood that, in some example embodiments, the setup process and the productivity assessment process may be combined together as one process, one or both of the processes may be further separated into two or more separate processes or sub-processes, or one or both of the processes may be combined with one or more other processes (e.g., one or more other productivity assessment processes) without departing from the teachings of the present disclosure. Alternatively and/or in addition, the setup process, the productivity assessment process and the recommendations to improve productivity process may be combined together as one process, one, two or three of the processes may be further separated into two or more separate processes or sub-processes, or one, two or three of the processes may be combined with one or more other processes (e.g., one or more other productivity assessment processes) without departing from the teachings of the present disclosure.

Alternatively and/or in addition, the system 100 is also configurable or configured to perform one or more other functions, operations, actions, methods, and/or processes, including those described in the present disclosure.

To perform the actions, functions, processes, and/or methods described above and in the present disclosure, example embodiments of the system 100 include one or more elements. Example embodiments of the system 100 are configurable or configured to perform these and other functions, actions, and/or processes, including those described in the present disclosure, via one or more elements of the system 100.

In example embodiments, the system 100 may include one or more users 10, one or more devices 10 of one or more users 10, or the like (referred to herein as a “user” 10). Such users 10 and/or user devices 10 may include, for example, mobile devices 10, tablet devices 10, wearable devices 10, AR and/or VR devices 10, laptop or other portable computing devices 10, desktop or other non-portable computing devices 10, workstation devices 10, networked computing devices 10, virtual computing devices 10, virtual instances of computing devices 10, cloud computing devices 10, and/or the like. Each user 10 and/or user device 10 may be configurable or configured to communicate, directly or indirectly, with one or more main processors 200 and/or one or more other elements of the system 100. For example, each user 10 and/or user device 10 is configurable or configured to communicate with the system 100 and to send or transmit (e.g., via network 50) a user request to manage a productivity of a user and/or a team. Each of the user 10 may also be configurable or configured to send or transmit one or more input data to the system 100. Each user 10 may also be configurable or configured to send or transmit, manage and/or store one or more input data to one or more user information database 30, including information for use in measuring productivity of the user 10.

In example embodiments, the system 100 may include and/or communicate with one or more user information databases 30 or the like. As will be further described in the present disclosure, the one or more user information databases 30 may be configurable or configured to manage, receive, identify, process, share, and/or store various information to be used by the system 100 to manage productivity of a user 10 and/or team 10. The user information database 30 may also store, but not limited to, information such as user data. Such user data may include, but is not limited to, personal data of a user (e.g., name, job position, identity, etc.), team information (e.g., team name, number of members in a team, size, position of each member, experience level of each member, experience of each member in working together in the team, hierarchy, etc.), one or more roles assigned to the team, one or more responsibilities assigned to the team, productivity assessment information (e.g., types of metrics, specific metrics, metrics determination, productivity assessment requirements, productivity assessment periods, etc.), historical information (e.g., historical productivity information, historical metrics determinations, historical productivity assessment period, productivity value for each metric, historical productivity score, historical recommendations on improving productivity for the future, etc.).

The system 100 may also include and/or communicate with one or more productivity management subsystem 40 or the like. As will be further described in the present disclosure, the one or more productivity subsystem 40 may be configurable or configured to manage, track, monitor, assess, analyze, process, identify, quantify, score, store, share, and/or report a productivity (or performance) of a user 10. For example, the productivity management subsystem 40 may include one or more resources (also referred to herein as tools and/or applications) such as, but not limited to, software development lifecycle (SDLC) tools, software management tools, productivity measurement tools, tools for quantifying productivity, tools for quantifying work performance, tracking tools, etc. The productivity management subsystem 40 may be configurable or configured to perform such actions alone or in cooperation with one or more other elements of the system 100, including the main processor 200.

The system 100 may also include and/or communicate with one or more networks 50, communication channels 50, or the like. Each network 50 is configurable or configured to enable communications between one or more elements of the system 100. For example, the network 50 may be configurable or configured to enable one or more users 10 to send one or more user requests to a main processor 200. As another example, the network 50 may be configurable or configured to enable a main processor 200 to identify and communicate with one or more user information databases 30, or the like. The network 50 may also be configurable or configured to enable a main processor 200 to identify and communicate with one or more productivity management subsystems 40 or the like. As another example, the network 50 may be configurable or configured to enable a first main processor 200 to communicate with one or more other main processors 200. As another example, the network 50 may be configurable or configured to enable a first main processor 200 to communicate with one or more other main processors 200.

As illustrated in at least FIGS. 1 and 2, an example embodiment of the system 100 may include one or more main processors 200. As will be further described in the present disclosure, each main processor 200 is configurable or configured to manage, control, search, access, store, receive and/or monitor one or more user information databases 30 or the like. Each main processor 200 is configurable or configured to search for, identify, select, compile, generate, transform, process, assess, and/or otherwise receive one or more user data for a setup process. Each main processor 200 is configurable or configured to perform a setup process using one or more user data. As will be further described in the present disclosure, each main processor 200 is configurable or configured to generate a positive set of metrics during the setup process. The main processor 200 is also configurable or configured to generate a negative set of metrics during the setup process. Further, the main processor 200 is configurable or configured to select one or more productivity assessment time periods during the setup process.

Each main processor 200 is also configurable or configured to search for, identify, select, compile, generate, transform, process, assess, and/or otherwise receive one or more productivity values for a productivity assessment process. The productivity values are generated for each metric in the positive set of metrics and each metric in the negative set of metrics. During a productivity assessment process, each main processor 200 is configurable or configured to perform a uniformity process. Further, each main processor is configurable or configured to generate a positive metric score for each of the metrics in the positive set of metrics and to generate a negative metric score for each of the metrics in the negative set of metrics.

Each main processor 200 is also configurable or configured to perform a first centroid generation process, a second centroid generation process, and/or a third centroid generation process. Each main processor 200 is configurable or configured to search for, identify, select, compile, generate, transform, process, assess, and/or otherwise receive one or more productivity score based on the productivity assessment process. Each main processor 200 is also configurable or configured to search for, identify, select, compile, generate, transform, process, assess, and/or otherwise suggest one or more recommendations for users to improve productivity based on the productivity assessment and/or productivity scores.

It is to be understood in the present disclosure that, although the functions and/or processes performed by the system 100 are described in the present disclosure as being performed by particular element(s) of the system 100, the functions and/or processes performed by a particular element of the system 100 may also be performed by one or more other elements and/or cooperatively performed by more than one element of the system 100 without departing from the teachings of the present disclosure. It is also to be understood in the present disclosure that, although the functions and/or processes performed by the system 100 are described in the present disclosure as being performed by particular elements of the system 100, the functions and/or processes performed by two or more particular elements of the system 100 may be combined and performed by one element of the system 100 without departing from the teachings of the present disclosure.

As used in the present disclosure, when applicable, a reference to a system (e.g., system 100), processor (e.g., main processor 200), elements of a system 100 and/or main processor 200, or the like, may also refer to, apply to, and/or include a computing device, processor, server, system, cloud-based computing, or the like, and/or functionality of a processor, computing device, server, system, cloud-based computing, or the like. The system 100 and/or main processor 200 (and/or its elements, as described in the present disclosure) may be any processor, server, system, device, computing device, controller, microprocessor, microcontroller, microchip, semiconductor device, or the like, configurable or configured to perform, among other things, a processing and/or managing of information, data communications, user requests, generating one or more elements, monitoring one or more elements, and/or any other actions described above and in the present disclosure. Alternatively or in addition, the system 100 and/or main processor 200 (and/or its elements, as described in the present disclosure) may include and/or be a part of a virtual machine, software, processor, computer, node, instance, host, or machine, including those in a networked computing environment.

As used in the present disclosure, a network and/or cloud may be a collection of devices connected by communication channels that facilitate communications between devices and allow for devices to share resources. Such resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof. A network 50, communication channel 50, cloud 50, or the like, may include, but is not limited to, computing grid systems 50, peer to peer systems 50, mesh-type systems 50, distributed computing environments 50, cloud computing environment 50, etc.

Such network 50, communication channel 50, cloud 50, or the like, may include hardware and software infrastructures configured to form a virtual organization comprised of multiple resources which may be in geographically disperse locations. Network 50 may also refer to a communication medium 50 between processes on the same device. Also as referred to herein, a network element, node, or server may be a device deployed to execute a program operating as a socket listener and may include software instances.

Example embodiments of the system 100 will now be described below with reference to the accompanying figures, which form a part of the present disclosure.

### The User (e.g., User 10).

As illustrated in at least FIG. 1, an example embodiment of the system 100 for managing the productivity of one or more users 10 includes and/or communicates with one or more users 10, teams 10, user devices of users 10, or the like (e.g., user 10, teams 10, or user device 10; also referred to herein as “user 10”). Each user 10 and/or user device 10 may be or include a mobile device 10, tablet device 10, wearable device 10, AR device, VR device, laptop or other portable computing device 10, desktop or other non-portable computing device 10, workstation 10, networked computing device 10, virtual computing device 10, virtual instances of a computing device 10, cloud computing device 10, and/or the like.

In an example, each user 10 is configurable or configured to communicate, directly or indirectly, with one or more main processors 200 and/or one or more other elements of the system (e.g., via network 50).

As an example, each user 10 is configurable or configured to communicate (e.g., via network 50) with one or more main processors 200, one or more user information databases 30 and/or one or more productivity management subsystems 40, as described in the present disclosure. The user 10 may send or transmit (e.g., via network 50) a user request to manage, monitor and/or assess the productivity of the user 10 and/or one or more other users 10. Alternatively or in addition, each user 10 may send or transmit (e.g., via network 50) a user request to manage, monitor and/or assess the productivity of the user 10 and/or one or more other users 10 at a selected or stipulated time period for productivity assessment.

As another example, the user 10 is configurable or configured to communicate (e.g., via network 50), to the main processor 200, information such as one or more input data or information. Such information from the user 10 may be any data or information received by and/or generated from one or more sources within and/or outside of the system 100, such as, but not limited to, input data or information related to the user 10, input data or information related to work assigned, in progress, and/or completed by the user 10, input data or information related to the productivity of the user 10, input data or information related to productivity measurements and/or scores, historical information of or relating to one or more of the foregoing, benchmark information of or relating to one or more of the foregoing, etc.

### The User Information Database (e.g., User Information Database 30)

As illustrated in FIG. 1, an example embodiment of the system 100 includes one or more user information databases 30 (e.g., user information database 30). Each user information database 30 is configurable or configured to perform a plurality of actions, functions, operations, methods, and/or processes, including managing productivity of one or more users 10. Each user information database 30 may also be configurable or configured to access, manage, store, receive, edit/change/delete, update, and/or otherwise utilize various information to be used by the system 100 to manage productivity of one or more users 10.

In an example embodiment, the user information database 30 may further include, but not limited to, information such as user data. Such user data may include personal data of a user (e.g., name, job position, identity, etc.), team information (e.g., team name, number of members in a team, size, position of each member, experience level of each member, experience of each member in working together in the team, hierarchy, etc.), one or more roles assigned to the team, one or more responsibilities assigned to the team, productivity assessment information (e.g., types of metrics, specific metrics, metrics determination, productivity assessment requirements, productivity assessment periods, etc.), historical information (e.g., historical productivity information, historical metrics determinations, historical productivity assessment period, productivity value for each metric, historical productivity score, historical recommendations on improving productivity for the future, etc.).

In example embodiments, the user information database 30 may be any centralized (or non-centralized) repository, customized (or non-customized) database, blockchain, or the like, for storing one or more information and/or tools to be used by the system 100 to manage productivity of a user 10 and/or team 10. As will be further described in the present disclosure, the one or more user information databases 30 is also configurable or configured to communicate with, and/or establish a connection with one or more main processors 200.

Although FIG. 1 may illustrate one user information database 30, it is to be understood that the system 100 may include more or less than one user information database 30 without departing from the teachings of the present disclosure.

### The Productivity Management Subsystem (e.g., Productivity Management Subsystem 40).

As illustrated in FIG. 1, an example embodiment of the system 100 may include one or more productivity management subsystems 40 (e.g., productivity management subsystem 40). Each productivity management subsystem 40 may be configurable or configured to perform a plurality of actions, functions, operations, methods, and/or processes, including performing and/or cooperating with the main processor 200 and/or one or more other elements of the system 100 to perform productivity management of one or more users 10, individuals 10, and/or teams 10. Each productivity management subsystem 40 may also be configurable or configured to cooperate with the main processor 200 and/or one or more other elements of the system 100 to manage, track, monitor, assess, analyze, process, identify, quantify, score, store, share, and/or report a productivity (or performance) of a user 10. In example embodiments, the productivity management subsystem may perform some, most or all actions of productivity processor 230. Alternatively or in addition, the productivity management subsystem may cooperate with the productivity processor 230 to perform certain actions, task, and/or functions.

The productivity management subsystem 40 may include and/or access one or more tools and/or applications such as productivity measurement tools, software development lifecycle (SDLC) tools, software management tools, tracking tools, tools for quantifying productivity, tools for quantifying work performance, etc. The productivity of the user 10 may be managed, tracked, monitored, assessed, analyzed, processed, identified, quantified, and/or scored, via the productivity management subsystem 40, using one or more of these tools and/or applications. Alternatively or in addition, the productivity management subsystem 40 may also be configurable or configured to determine or generate a productivity value and/or cooperate with the main processor 200 to do so. Further, the productivity management subsystem 40 is configurable or configured to store, share and/or report the one or more results and/or assessments generated and derived from the one or more tools and/or applications.

To perform the one or more functions, the productivity management subsystem 40 may be configurable or configured to generate or select one or more metrics pertaining to productivity and/or performance of the user 10 (e.g., team, developers, etc.). Such one or more metrics may be generated or selected by the productivity management subsystem 40, obtained or received from the main processor 200, and/or generated or selected by a cooperation of the productivity management subsystem 40 and the main processor 200.

In an example embodiment, the productivity management subsystem 40 generates a result (e.g., productivity value) for each of the metrics. For example, the productivity management subsystem 40 may receive one or more metrics to be generated, assessed and/or quantified. The one or more metrics may include a positive set of metrics and a negative set of metrics. The positive set of metrics may refer to metrics for which higher values are more desirable. Examples of positive metrics include, but not limited to, a metric for measuring story points delivered, a metric for measuring user stories delivered, a metric for measuring story points delivered relative to story points committed, a metric for measuring software code pushed within normal working hours, a metric for measuring a quantity of software code pushed by the team within normal working hours relative to a quantity of software code committed, a metric for measuring product change requests, and/or a metric for measuring a team velocity or quantity of work that can be accomplished. Further, the negative set of metrics may refer to metrics for which lower values are more desirable (e.g., lesser code bugs, lesser job failures, etc.). Examples of negative metrics include, but not limited to, a metric for measuring a quantity of software bugs detected, a metric for measuring a cycle time or time to market, a metric for measuring a quantity of production incidents, a metric for measuring a quantity of job failures, a metric for measuring code bug diversity, and/or a metric for measuring code bug density over a selected number of programming files. Please refer to FIG. 6 as an example of a selected negative set of metrics and a selected positive set of metrics arranged on a radar chart (e.g., radar chart 600). The selected positive set of metrics and the selected negative set of metrics may be generated, assessed and/or quantified using one or more tools and/or applications in the productivity management subsystem 40 to achieve a productivity value for each metrics. For example, one or more SDLC tools may be used such as, but not limited to, Enterprise JIRA, Bitbucket, Jenkins, SonarQube, or the like. Alternatively or in addition, the productivity value for each selected metrics may also be generated or obtained from an external source, database and/or assessment tools.

Each of the positive set of metrics is selected based on the negative set of metrics and each metric of the negative set of metrics is selected based on the positive set of metrics. Each metric in the positive set of metrics may be related to at least one metric in the negative set of metrics. Each metric in the positive set of metrics may also be complementary to at least one metric in the negative set of metrics. For example, one or more metrics of the positive set of metrics and the negative set of metrics may be paired, such as complementarily or opposingly (e.g., with more story points delivered, it would be desirable for there to be less bugs). Each metric is not limited to complementing only one other metric, and there may be an odd or even number of metrics.

For example, Table 1 includes a set of ten (10) metrics which may include five (5) positive metrics and four (4) negative metrics. Each metric is complementary (or otherwise related) to another. Any number of the ten (10) metrics may be selected for productivity assessment. See FIG. 6 as a further example.

TABLE 1
Productivity metrics with its complementary (or opposing) metrics.

| Positive Metric | | Negative Metric |
|---|---|---|
| (1) number of story points | complementary to | (6) number of software bugs or |
| delivered 620 | | numeric value representing |
| | | software bugs 610 |
| (2) percentage or ratio of number | complementary to | (7) number of software bugs or |
| of story points delivered to | | numeric value representing |
| number of story points committed | | software bugs 610 |
| 602 | | |
| (3) percentage or ratio of quantity | complementary to | (8) cycle time to market (e.g., in |
| of code pushed out of quantity of | | terms of business days or |
| total code committed, within | | working hours) 612 |
| working hours (e.g., 9 am to 6 pm, | | (9) lead time |
| Monday to Friday) 604 | | |
| (4) number of production change | complementary to | (10) production incidents 614 |
| requests or software change | | |
| requests 606 | | |
| (5) velocity or quantity of work | complementary to | (11) percentage of job failures |
| that can be accomplished 608 | | out of total tasks completed 616 |
| | | (12) Code bug density over a |
| | | selected number of |
| | | programming files (e.g., 1,000 |
| | | programming files) |

For example, in Table 1, only change requests 606 which are successfully closed may count towards the measurement of the metric, and change requests 606 related to infrastructure or non-software changes may not. For example, in Table 1, production incidents 614 may refer to outages due to technical or functional changes, capacity issues, system bugs, etc. as an indication of operation stability. For example, in Table 1, job failures 616 may refer to failures to build a software package or failures to do any required scans or other failures to perform requirements as part of continuous integration and continuous delivery, as an indication of software compilation, packaging, and/or deployment success. For example, in Table 1, code bug density over a selected number of programming files may refer to the amount of bugs across a selected number of programming files in relation to the number of file changes.

Once a productivity value is determined for each metric selected, the productivity management subsystem 40 may store, share and/or report one or more of the results (e.g., productivity value) of the metric assessment to the system 100 to the main processor 200 and/or to the one or more elements of the system 100 and/or the main processor 200. The generated or determined productivity value for each metric may also be stored in the productivity management subsystem 40 for future reference or use.

The productivity management subsystem 40 may perform some or all of the above actions in real-time or near real-time. Alternatively or in addition, the productivity management subsystem 40 may also perform the above actions upon receiving a command or request from the system 100 and/or main processor 200. Alternatively or in addition, the productivity management subsystem 40 may also perform the above actions upon an occurrence (and/or non-occurrence) of an event related to work and work productivity, an update to current or existing work and/or work productivity arrangements, etc. Alternatively or in addition, the productivity management subsystem 40 may also store one or more historic results and/or assessments generated and derived from the one or more tools and/or applications on previous assessments, a benchmark/standard/average score for each metrics, etc.

In example embodiments, the productivity management subsystem 40 may select and/or generate (and/or cooperate with one or more other elements of the system 100 to select and/or generate) one or more of the productivity metrics described above and in the present disclosure for particular users 10 in the form of a matrix, template, table, structured dataset, or the like (e.g., radar chart 600), which is then called on, accessible by, and/or provided to one or more elements of the main processor 200 (e.g., the productivity processor 230) for use in generating actual values and scores and populating such values and scores for storage (e.g., in the user information database 30), including productivity scores, for users 10. Alternatively or in addition, one or more such actions can be performed entirely by the productivity management subsystem 40. Alternatively or in addition, one or more such actions can be performed entirely by one or more elements of the main processor 200 (e.g., the productivity processor 230).

Although FIG. 1 may illustrate one productivity management subsystem 40, it is to be understood that the system 100 may include more or less than one productivity management subsystem 40 without departing from the teachings of the present disclosure.

### The Main Processor (e.g., Main Processor 200).

As illustrated in FIG. 1 and FIG. 2, an example embodiment of the system 100 includes one or more main processor (e.g., main processor 200). The main processor 200 is configurable or configured to perform a plurality of actions, functions, operations, methods, and/or processes, including managing productivity of one or more users 10, individuals 10, and/or teams 10.

As a non-limiting example, each main processor 200 may include one or more elements configurable or configured to perform a variety of actions, functions, operations, methods, and/or processes, including, but not limited to, managing productivity of a user 10. More specifically, the main processor 200 is configurable or configured to manage, monitor and/or assess the productivity of one or more users 10 at a selected or stipulated time period. The main processor 200 is further configurable or configured to search for, identify and/or communicate with one or more user information databases 30.

The main processor 200 is also configurable or configured to manage, store, and/or retrieve various information from the user information database 30 to be used by the system 100 to manage productivity of one or more users 10. The main processor 200 is configurable or configured to communicate with the one or more user information databases 30 to access, manage, store, receive, edit/change/delete, update, and/or otherwise utilize information to be used by the system 100 to manage productivity of a user 10 and/or team 10. As described in the present disclosure, the user information database 30 may include information such as user data. The main processor 200, when performing a setup process and/or productivity assessment process (as will be described further in the present disclosure), may utilize information such as user data which may include, but is not limited to, personal data of a user (e.g., name, job position, identity, etc.), team information (e.g., team name, number of members in a team, size, position of each member, experience level of each member, experience of each member in working together in the team, hierarchy, etc.), one or more roles assigned to the team, one or more responsibilities assigned to the team, productivity assessment information (e.g., types of metrics, specific metrics, metrics determination, productivity assessment requirements, productivity assessment periods, etc.), historical information (e.g., historical productivity information, historical metrics determinations, historical productivity assessment period, historical productivity value for each metric, historical productivity score, historical recommendations on improving productivity for the future, etc.).

The main processor 200 is also configurable or configured to manage, store, and/or retrieve various information relating to the to be used by the system 100 to manage productivity of one or more users 10. The main processor 200 is configurable or configured to communicate with the one or more user information databases 30 to access, manage, store, receive, edit/change/delete, update, and/or otherwise utilize various information to be used by the system 100 to manage productivity of a user 10 and/or team 10.

The main processor 200 is configurable or configured to manage, store, and/or retrieve various information from the productivity management subsystem 40 to be used by the system 100 to manage productivity of one or more users 10. The main processor 200 is configurable or configured to communicate with the one or more productivity management subsystem 40 to access, manage, store, receive, edit/change/delete, update, and/or otherwise utilize information to be used by the system 100 to manage productivity of a user 10 and/or team 10. As described in the present disclosure, the productivity management subsystem 40 may include information derived from one or more tools and/or applications for managing productivity (or performance) of a user 10 and for managing productivity (or performance) to be used by the system 100 to manage productivity of a user 10 and/or team 10. The information may include determinations from one or more metrics pertaining to productivity and/or performance of the user 10. Examples of metrics measured include story points delivered, user stories delivered, quantity of work accomplished, team velocity in accomplishing work, etc. Such information may be generated from one or more tools and/or applications in the productivity management subsystem 40, but not limited to, productivity measurement tools, software development lifecycle (SDLC) tools, software management tools, tracking tools, tools for quantifying productivity, tools for quantifying work performance, etc. Alternatively or in addition, the main processor 200 may retrieved and/or obtain such information that has been generated and/or stored in the productivity management subsystem 40.

The main processor 200, when performing a setup process and/or productivity assessment process (as will be described further in the present disclosure), may utilize information such as user data which may include, but is not limited to, personal data of a user, team information, one or more roles assigned to the team, one or more responsibilities assigned to the team, productivity assessment information, and/or historical information.

In example embodiments, the main processor 200 is also configurable or configured to perform a setup process. The setup process establishes a new process (e.g., managing productivity of one or more user 10). The setup process may be performed when the main processor 200 receives a request or a command from a user 10 and/or the system 100 to manage productivity of a user 10. More specifically, the setup process may be performed when the main processor 200 receives a request or a command from a user 10 and/or the system 100 to manage productivity of a user 10 to manage, monitor and/or assess the productivity of one or more users 10 at a selected or stipulated time period for productivity assessment. Alternatively or in addition, the setup process may not be required if the setup process has been performed during the first productivity assessment process and if the subsequent productivity assessment process is a productivity assessment for the same one or more users 10 and/or for the same one or more metrics.

As an example embodiment of a setup process performed by the main processor 200, the setup process may include identifying one or more team information for the team 10. The team information may include, but not limited to, personal data of each user 10 in the team 10 (e.g., name, job position, identity, etc.), team information (e.g., team name, number of members in a team, size, position of each member, experience level of each member, experience of each member in working together in the team, hierarchy, etc.), one or more roles assigned to the team, one or more responsibilities assigned to the team, productivity assessment information of the team (e.g., types of metrics, specific metrics, metrics determination, productivity assessment requirements, productivity assessment periods, etc.), historical information (e.g., historical productivity information, historical metrics determinations, historical productivity assessment period, productivity value for each metric, historical productivity score, historical recommendations on improving productivity for the future, etc.).

The setup process, as performed by the main processor 200, may also include generating a positive set of metrics. The positive set metrics includes a first quantity of quantifiable productivity metrics, as will be described further in the present disclosure. Examples of positive metrics include, but not limited to, a metric for measuring story points delivered, a metric for measuring user stories delivered, a metric for measuring story points delivered relative to story points committed, a metric for measuring software code pushed within normal working hours, a metric for measuring a quantity of software code pushed by the team within normal working hours relative to a quantity of software code committed, a metric for measuring product change requests, and/or a metric for measuring a team velocity or quantity of work that can be accomplished.

The setup process, as performed by the main processor 200, also includes generating a negative set of metrics. The negative set metrics includes a second quantity of quantifiable productivity metrics, as will be described further in the present disclosure. Examples of negative metrics include, but not limited to, a metric for measuring a quantity of software bugs detected, a metric for measuring a cycle time or time to market, a metric for measuring a quantity of production incidents, a metric for measuring a quantity of job failures, a metric for measuring code bug diversity, and/or a metric for measuring code bug density over a selected number of programming files. During the setup process, each of the positive set of metrics is selected based on the negative set of metrics and each metric of the negative set of metrics is selected based on the positive set of metrics. Further, the setup process also includes selecting a productivity assessment time period, wherein the assessment of the team's productivity is performed during the selected assessment time period only.

In example embodiments, the main processor 200 is further configurable or configured to perform a productivity assessment process. The productivity assessment process may be performed when the main processor 200 receives a request or a command from a user 10 and/or the system 100 to manage productivity of a user 10. More specifically, the productivity assessment process may be performed when the main processor 200 receives a request or a command from a user 10 and/or the system 100 to manage productivity of a user 10 to manage, monitor and/or assess the productivity of one or more users 10 at a selected or stipulated time period for productivity assessment.

The productivity assessment process for users 10 includes obtaining a productivity value for each metric in the positive set of metrics and obtaining a productivity value for each metric in the negative set of metrics. The productivity value obtained for each metric in the positive set of metrics include a quantity of or a measure of, but not limited to, story points delivered 620, user stories delivered, story points delivered relative to story points committed 602, software code pushed within normal working hours 604, software code pushed by the team within normal working hours relative to software code committed, product change requests, and/or team velocity or quantity of work that can be accomplished 608.

Furthermore, the productivity assessment process also includes obtaining a productivity value each metric in the negative set of metrics. The productivity value obtained for each metric in the negative set of metrics include a quantity of or a measure of, but not limited to, software bugs detected 610, a cycle time or time to market 612, production incidents 614, job failures 616, and/or code bug diversity and/or density over a selected number of programming files. Alternatively or in addition, the productivity values for each metric may be obtained from the productivity management subsystem 40 as described in the present disclosure.

The main processor 200 is also configured or configurable, during the productivity assessment process, to perform a uniformity process. As each metrics of the positive set of metrics and the negative set of metrics has different quantity units and/or measurement units and are measured on different units/scales, the uniformity process is performed to normalize or transform the quantity units or measurement units of each metrics into a comparable and unitless score or units and/or a common scale (e.g., a metric score, a positive metric score, a negative metric score, etc.) (e.g., metric score 703). The one or more positive metric scores and the one or more negative metric scores are scores obtained within a specific time period during the selected productivity assessment time period. Further, the scores are obtained using calculations or determinations which will be further described in the present disclosure.

The main processor 200 is also configured or configurable, during the productivity assessment process, to perform a first centroid generation process, a second centroid generation process and/or a third centroid generation process. The first centroid generation process is to determine an overall centroid value (e.g., overall centroid value 701) based on a first resultant shape generated by plotting each of the generated positive metric score for each metric in the positive set of metrics and each of the generated negative metric score for each metric in the negative set of metrics (see, for example, FIG. 7). The second centroid generation process is to determine a maximum centroid value (e.g., maximum centroid value 801) based on a second resultant shape generated by plotting each of the selected positive maximum value for each metric in the positive set of metrics and each of the selected negative minimum value for each metric in the negative set of metrics (see, for example, FIG. 8). The third centroid generation process is to determine a minimum centroid value (e.g., minimum centroid value 901) based on a third resultant shape generated by plotting each of the selected positive minimum value for each metric in the positive set of metrics and each of the selected negative maximum value for each metric in the negative set of metrics (see, for example, FIG. 9). Further steps when performing the first centroid generation process, the second centroid generation process and the third centroid generation process will be further described in the present disclosure.

The main processor 200 is also configured or configurable, during the productivity assessment process, to generate one or more productivity scores. The productivity score for the one or more users 10 and/or teams 10 may be generated based on one or more distances from the overall centroid value 701 of the first resultant shape and the maximum centroid value 801 for the second resultant shape (see, for example, FIG. 10). The productivity score may also be generated based on and one or more distances from the maximum centroid value 801 for the second resultant shape and the minimum centroid value 901 for the third resultant shape (see, for example, FIG. 10). Further, the productivity score may also be generated based on one or more distances from the overall centroid value 701 of the first resultant shape and the minimum centroid value 901 for the third resultant shape.

Alternatively or in addition, a productivity scaling number may be used when generating one or more productivity scores. In this example embodiment, the productivity scaling number may be a unitless score, digit, number, unit and/or a common scale. For example, the productivity score may be generated by subtracting the productivity scaling number from a number obtained by dividing the first distance with the second distance, subtracting the productivity scaling number from a number obtained by dividing the third distance with the second distance, subtracting the productivity scaling number from a number obtained by dividing the second distance with the first distance, subtracting the productivity scaling number from a number obtained by dividing the second distance with the third distance, and/or subtracting the productivity scaling number from a number obtained by dividing the first distance with the third distance. Alternatively or in addition, the one or more productivity scores may also be generated by dividing the third distance with the first distance, dividing the third distance with the second distance, dividing the second distance with the first distance, dividing the second distance with the third distance, dividing the first distance with the third distance, and/or dividing the third distance with the first distance.

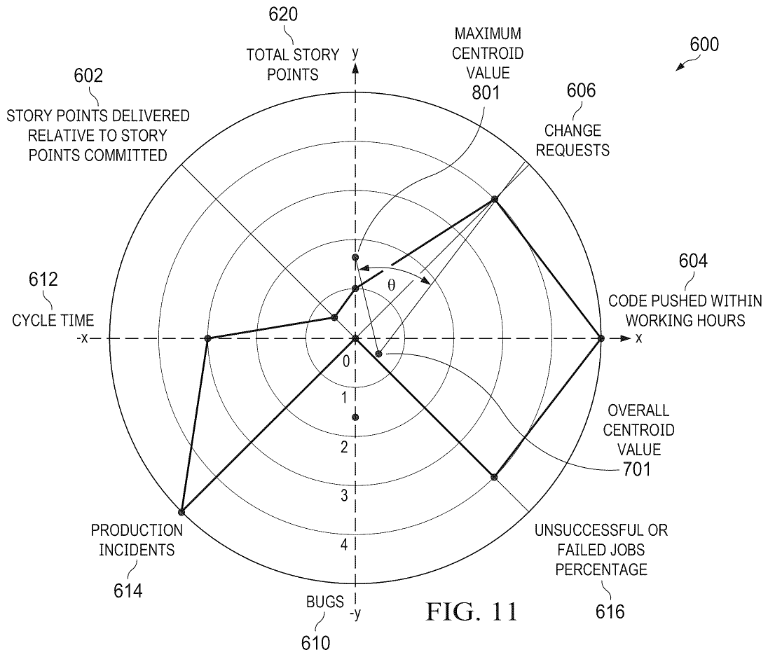

The main processor 200 may also be configured or configurable, during the productivity assessment process, to generate one or more recommendations for users 10 to improve productivity based on the productivity assessment and/or one or more productivity scores. In an example embodiment, the main processor 200, during the productivity assessment process, obtains the one or more productivity values, through one or more options which have been described in the present disclosure. For each metric in the positive set of metrics, one or more recommendations on improving the productivity of the team 10 may be generated, by forming a first line between the overall centroid value 701 and the maximum centroid value 801. The recommendations on improving the productivity of user 10 may be generated by forming a second line between the overall centroid value 701 and a positive maximum value for the metric. Further, the recommendations on improving the productivity of the user 10 may also be generated by identifying a first angle formed between the first and second lines. Please see FIG. 11 as an example. As for each metric in the negative set of metrics, the main processor 200 may be configured or configurable to generate one or more recommendations on improving the productivity of the team 10 by forming a third line between the overall centroid value 801 and the minimum centroid value 901. The recommendations on improving the productivity of the user 10 may be generated by forming a fourth line between the overall centroid value 701 and a negative minimum value for the metric. Further, the recommendations on improving the productivity of the user 10 may also be generated by identifying a second angle formed between the third and fourth lines.

To perform the actions, functions, processes, and/or methods described above and in the present disclosure, example embodiments of the main processor 200 include one or more elements.

For example, as illustrated in at least FIG. 2, the main processor 200 includes one or more main interfaces (e.g., main interface 210). The main processor 200 also includes one or more setup processors 220 (e.g., setup processor 220). The main processor includes one or more productivity processor 230 (e.g., productivity processor 230).

Although the figures may illustrate the main processor 200 as having one main interface 210, one setup processor 220, and one productivity processor 230, it is to be understood that the main processor 200 may include more or less than one main interface 210, more or less than one setup processor 220, and/or more or less than one productivity processor 230 without departing from the teachings of the present disclosure. For example, the main processor 200 may include one or more setup processors 220 configurable or configured to perform some, most, and/or all of the functions of the main interface 210, the setup processor 220, and/or the productivity processor 230. As another example, the main processor 200 may include one or more productivity processors 230 configurable or configured to perform some, most, and/or all of the functions of the main interface 210, the setup processor 220, and/or productivity processors 230. Each of the elements of the main processor 200 may be configurable or configured to connect to, communicate with, and/or receive communications from one or more users 10, one or more computing devices 10, one or more user information databases 30, one or more networks 40, one or more other systems 100, and/or one or more other main processors 200.

As used in the present disclosure, when applicable, a reference to a “system”, “processor”, system 100 (and/or one of its elements), processor 200 (and/or one of its elements), main processor 200 (and/or one of its elements), interface 210 (and/or one of its elements), main interface (and/or one of its elements), setup processor 220 (and/or one of its elements), and/or productivity processor 230 (and/or one of its elements) may also refer to, apply to, and/or include one or more computing devices, processors, servers, systems, cloud-based computing, virtual machines, AI machines, or the like, and/or functionality of one or more processors, computing devices, servers, systems, cloud-based computing, virtual machines, AI machines, or the like. The “system”, “processor”, system 100 (and/or one of its elements), processor 200 (and/or one of its elements), main processor 200 (and/or one of its elements), interface 210 (and/or one of its elements), main interface 210 (and/or one of its elements), setup processor 220 (and/or one of its elements), and/or productivity processor 230 (and/or one of its elements) may be any processor, server, system, device, computing device, controller, microprocessor, microcontroller, microchip, semiconductor device, or the like, configurable or configured to perform the actions, steps, methods, processes, and/or the like, described in the present disclosure. Alternatively or in addition, the “system”, “processor”, system 100 (and/or one of its elements), processor 200 (and/or one of its elements), main processor 200 (and/or one of its elements), interface 210 (and/or one of its elements), main interface 210 (and/or one of its elements), setup processor 220 (and/or one of its elements), and/or productivity processor 300 may include and/or be a part of a virtual machine, processor, computer, node, instance, host, or machine, including those in a networked computing environment. Furthermore, the terms “data” and “information” may be used interchangeably in the present disclosure to refer to data and/or information without departing from the teachings of the present disclosure.

As used in the present disclosure, a communication channel 50, network 50, cloud 50, or the like, may be or include a collection of devices and/or virtual machines connected by communication channels that facilitate communications between devices and allow for devices to share resources. Such resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof. A communication channel 50, network 50, cloud 50, or the like, may include, but is not limited to, computing grid systems, peer to peer systems, mesh-type systems, distributed computing environments, cloud computing environment, telephony systems, voice over IP (VOIP) systems, voice communication channels, voice broadcast channels, text-based communication channels, video communication channels, etc. Such communication channels 50, networks 50, clouds 50, or the like, may include hardware and software infrastructures configured to form a virtual organization comprised of multiple resources which may be in geographically disperse locations. Communication channel 50, network 50, cloud 50, or the like, may also refer to a communication medium between processes on the same device. Also as referred to herein, a network element, node, or server may be a device deployed to execute a program operating as a socket listener and may include software instances.

It is to be understood in the present disclosure that one or more elements, actions, and/or aspects of example embodiments may include and/or implement, in part or in whole, solely and/or in cooperation with other elements, using, for example, networking technologies, cloud computing, distributed ledger technology (DLT) (e.g., blockchain), artificial intelligence (AI), machine learning, deep learning, etc.

These and other elements of the processor 200 will now be further described with reference to the accompanying figures.

### The Main Interface (e.g., Main Interface 210).

As illustrated in at least FIG. 2, an example embodiment of the main processor 200 includes one or more main interface (e.g., main interface 210). Each main interface is configurable or configured to perform one or more of a plurality of functions, operations, actions, methods, and/or processes, including, but not limited to, receive, process, and/or manage requests and/or commands received from one or more elements of the system 100. Each main interface 210 is also configurable or configured to communicate with one or more elements of the system 100, including one or more users 10, one or more user information databases 30, and one or more networks 40. Each main interface 210 is also configurable or configured to communicate with one or more elements of the system 100, including one or more databases (not shown), and/or one or more communication channels (not shown). Each main interface 210 is configurable or configured to receive, request, retrieve, and/or obtain information from one or more information sources (e.g., user information) and/or resources (e.g., tools and/or applications). The one or more information sources and/or resources may be related to or include, but are not limited to, users 10, user devices 10, user information databases 30, productivity management subsystem 40, networks 50, communication channels 50, other elements of the main processor 200, etc.

In an example embodiment, the main interface 210 may receive information pertaining to a user 10 and/or user device 10. The information may be received, by the main interface 210, from the one or more user 10. As described in the present disclosure, a user 10 may be users 10, teams 10, user devices of users 10, or the like (e.g., user 10, teams 10, or user device 10). Each user 10 and/or user device 10 may be or include a mobile device 10, tablet device 10, wearable device 10, AR device, VR device, laptop or other portable computing device 10, desktop or other non-portable computing device 10, workstation 10, networked computing device 10, virtual computing device 10, virtual instances of a computing device 10, cloud computing device 10, and/or the like.

In another example embodiment, the main interface 210 may also receive (or retrieve) information pertaining to a user 10 and/or user device 10 from one or more user information database 30. As described in the present disclosure, the main interface 210 is configurable or configured to communicate with one or more user information databases 30. The user information database 30 may also store, but not limited to, information such as user data. The main interface 210 may receive (or retrieve) such user data including, but is not limited to, personal data of a user (e.g., name, job position, identity, etc.), team information (e.g., team name, number of members in a team, size, position of each member, experience level of each member, experience of each member in working together in the team, hierarchy, etc.), one or more roles assigned to the team, one or more responsibilities assigned to the team, productivity assessment information (e.g., types of metrics, specific metrics, metrics determination, productivity assessment requirements, productivity assessment periods, etc.), historical information (e.g., historical productivity information, historical metrics determinations, historical productivity assessment period, productivity value for each metric, historical productivity score, historical recommendations on improving productivity for the future, etc.).

As an example, during a setup process for managing productivity of a user 10, the main interface 210, as described above and in the present disclosure, may receive one or more information from the user 10 and/or one or more user information databases 30. The information received may be team information for the team 10. The information may include, but not limited to, personal data of a user (e.g., name, job position, identity, etc.), team information (e.g., team name, number of members in a team, size, position of each member, experience level of each member, experience of each member in working together in the team, hierarchy, etc.), one or more roles assigned to the team, one or more responsibilities assigned to the team, productivity assessment information of the team (e.g., types of metrics, specific metrics, metrics determination, productivity assessment requirements, productivity assessment periods, etc.), historical information (e.g., historical productivity information, historical metrics determinations, historical productivity assessment period, historical productivity value for each metric, historical productivity score, historical recommendations on improving productivity for the future, etc.).

The information received by the main interface 210 may be received or retrieved when the main processor 200 receives a command and/or request to initiate a setup process or a productivity assessment process. The information received by the main interface 210 may be received in real-time and/or near real-time. Alternatively or in addition, the information may also be received when there are changes, edits, deletions, additions, updates, etc. to the one or more team information. The main interface 210 may also be configurable or configured to communicate with the user information database 30 to update and/or store the one or more team information that have gone through changes, edits, deletions, additions, updates, etc.

The main interface 210 is also configurable or configured to communicate with one or more setup processor 220 and/or one or more productivity processor 230 as will be further described in the present disclosure.

### The Setup Processor (e.g., Setup Processor 220).

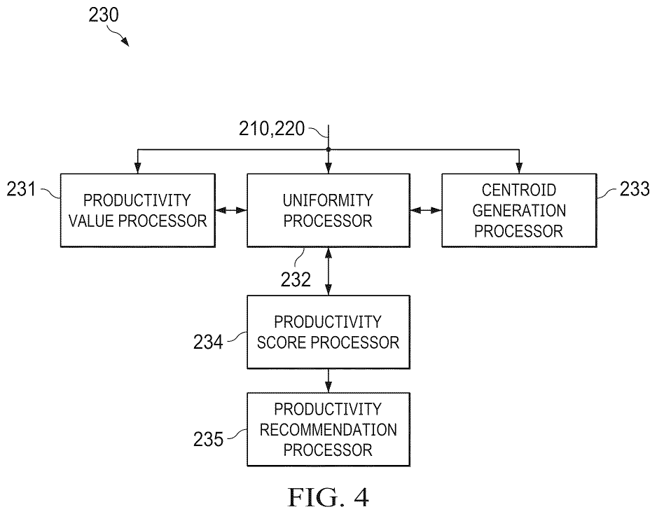

As illustrated in at least FIG. 2 and FIG. 4, the main processor 200 includes and/or communicates with one or more setup processors (e.g., setup processor 220). The setup processor 220 is configurable or configured to perform one or more of a plurality of functions, operations, actions, methods, and/or processes, including, but not limited to, identifying one or more elements of the system 100.

For example, the setup processor 220 is configurable or configured to perform a setup process. During a setup process, the setup processor 220 is configurable or configured to search for, identify, select, compile, generate, transform, process, assess, and/or otherwise receive information and/or requests (e.g., requests received from one or more users 10 for productivity assessment, requests received from one or more users 10 for productivity recommendations, etc.) from one or more elements of the system 100, including one or more users 10, one or more user information databases 30, one or more productivity management subsystems 40, one or more networks 50, and/or one or more other system 100 and/or processors 200. The setup processor 220 is also configurable or configured to receive one or more team information from the users 10 and/or the main interface 210. The setup processor 220 is configurable or configured to receive one or more productivity values, information relating to productivity, information relating to selected positive set of metrics, selected negative set of metrics, etc. from the productivity processor 230. Alternatively or in addition, the setup processor 220 may also be configurable or configured to communicate with the system 100 and/or the other elements of the system 100 including the user information database 30 and/or the productivity management subsystem 40 to receive one or more input. To perform the actions, functions, processes, and/or methods described above and in the present disclosure, example embodiments of the setup processor 220 include one or more elements.

As illustrated in FIG. 3, the setup processor 220 includes one or more team information processors (e.g., team information processor 221). The setup processor 220 includes one or more metrics generators (e.g., metrics generators 222). The setup processor 220 includes one or more time period processors (e.g., time period processor 223). The elements of the setup processor 220 will now be further described with reference to the accompanying figures.

### The Team Information Processors (e.g., Team Information Processor 221).

As illustrated in FIG. 3, an example embodiment of the setup processor 220 includes one or more team information processors (e.g., team information processor 221). The team information processor 221 is configurable or configured to receive, generate and/or identify one or more team information for the user 10 (and the team 10) from the main interface 210. The team information processor 221 is configurable or configured to identify the user 10 (and the team 10) that is to be assessed and to identify one or more information related to the user 10 (and the team 10) for the assessment purposes.

The team information may include, but not limited to, personal data of a user (e.g., name, job position, identity, etc.), team information (e.g., team name, number of members in a team, size, position of each member, experience level of each member, experience of each member in working together in the team, hierarchy, etc.), one or more roles assigned to the team, one or more responsibilities assigned to the team, productivity assessment information of the team (e.g., types of metrics, specific metrics, metrics determination, productivity assessment requirements, productivity assessment periods, etc.), historical information (e.g., historical productivity information, historical metrics determinations, historical productivity assessment period, productivity value for each metric, historical productivity score, historical recommendations on improving productivity for the future, etc.).

Alternatively or in addition, the team information processor 221 may also be configurable or configured to store, update, delete, amend, change, etc. one or more team information. The team information processor may be configurable or configured to provide, send and/or make available the output results (e.g., team information, user information, etc.) to the one or more elements in the system 100 including the metric generators 222, and/or one or more productivity processors 230, as described in the present disclosure.

### The Metrics Generators (e.g., Metrics Generator 222).

As illustrated in FIG. 3, an example embodiment of the setup processor 220 includes one or more metrics generators (e.g., metrics generator 222). The metrics generator 222 is configurable or configured to generate a set of metrics to be assessed, measured, quantified, and/or processed for managing one or more users 10. Depending on the specifics in the request and/or command received, or productivity assessment to be performed, the metrics to be generated for a selected or specified productivity assessment time period includes one or more positive set of metrics and/or one or more negative set of metrics.

The positive set metrics includes a first quantity of quantifiable productivity metrics. Examples of positive metrics include, but not limited to, a metric for measuring story points delivered 620, a metric for measuring user stories delivered, a metric for measuring story points delivered relative to story points committed 602, a metric for measuring software code pushed within normal working hours 604, a metric for measuring a quantity of software code pushed by the team within normal working hours relative to a quantity of software code committed, a metric for measuring product change requests 606, and/or a metric for measuring a team velocity or quantity of work that can be accomplished 608. In addition, the metrics generator 222 is configurable or configured to generate a negative set of metrics. The negative set metrics includes a second quantity of quantifiable productivity metrics. Examples of negative metrics include, but not limited to, a metric for measuring a quantity of software bugs detected 610, a metric for measuring a cycle time or time to market 612, a metric for measuring a quantity of production incidents 614, a metric for measuring a quantity of job failures 616, and/or a metric for measuring code bug diversity and/or density over a selected number of programming files.

During the setup process, each of the positive set of metrics is selected based on the negative set of metrics and each metric of the negative set of metrics is selected based on the positive set of metrics. The first quantity of quantifiable productivity metrics is equal to the second quantity of quantifiable productivity metrics. In an example embodiment, the metrics generator 222 may be configurable or configured to receive, determine, generate, or select one or more metrics pertaining to productivity and/or performance of the user 10 (e.g., team, developers, etc.). Each of the metrics may be received, determined, generated, or selected by one or more tools and/or applications, depending on the specifics in the request, command and/or productivity assessment to be performed. Alternatively or in addition, the metrics pertaining to productivity and/or performance may also be received or retrieved from the one or more productivity management subsystem 40.

The one or more metrics include a positive set of metrics and a negative set of metrics. The positive set of metrics may refer to metrics for which higher values are more desirable. Further, the negative set of metrics may refer to metrics for which lower values are more desirable (e.g., lesser code bugs, lesser job failures, etc.). Each of the metrics of the positive set of metrics is selected based on the negative set of metrics and each metric of the negative set of metrics is selected based on the positive set of metrics. Each of the metrics in the positive set of metrics is related to at least one or the metric in the negative set of metrics. Each of the metrics in the positive set of metrics is also complementary to at least one of the metrics in the negative set of metrics. For example, one or more metrics of the positive set of metrics and the negative set of metrics may be paired, such as complementarily or opposingly (e.g., with more story points delivered, it would be desirable for there to be less bugs). Each metric is not only limited to complementing only one other metric, and there may be an odd or even number of metrics.

For example, Table 2 includes a set of ten (10) metrics which may include five (5) positive metrics and four (4) negative metrics. Each metric is complementary (or otherwise related) to another. It is to be understood that any number of metrics may be selected for productivity assessment. See FIG. 6 as a further example.

TABLE 2
Productivity metrics with its complementary (or opposing) metrics.

| Positive Metric | | Negative Metric |
|---|---|---|
| (1) number of story points | complementary to | (6) number of software bugs or |
| delivered 620 | | numeric value representing |
| | | software bugs 610 |
| (2) percentage or ratio of number | complementary to | (7) number of software bugs or |
| of story points delivered to | | numeric value representing |
| number of story points committed | | software bugs 610 |
| 602 | | |
| (3) percentage or ratio of quantity | complementary to | (8) cycle time to market (e.g., in |
| of code pushed out of quantity of | | terms of business days or |
| total code committed, within | | working hours) 612 |
| working hours (e.g., 9 am to 6 pm, | | (9) lead time |
| Monday to Friday) 604 | | |
| (4) number of production change | complementary to | (10) production incidents 614 |
| requests or software change | | |
| requests 606 | | |
| (5) velocity or quantity of work | complementary to | (11) percentage of job failures |
| that can be accomplished 608 | | out of total tasks completed 616 |
| | | (12) Code bug density over a |
| | | selected number of |
| | | programming files (e.g., 1,000 |
| | | programming files) |

For example, in Table 2, only change requests 606 which are successfully closed may count towards the measurement of the metric, and change requests 606 related to infrastructure, or non-software changes may not. For example, in Table 1, production incidents 614 may refer to outages due to technical or functional changes, capacity issues, system bugs, etc. as an indication of operation stability. For example, in Table 2, job failures 616 may refer to failures to build a software package or failures to do any required scans or other failures to perform requirements as part of continuous integration and continuous delivery, as an indication of software compilation, packaging, and/or deployment success. For example, in Table 1, code bug density over a selected number of programming files may refer to the amount of bugs across a selected number of programming files in relation to the number of file changes.

### The Time Period Processors (e.g., Time Period Processor 223).

As illustrated in FIG. 3, an example embodiment of the setup processor 220 includes one or more time period processors (e.g., time period processor 223). The time period processor 223 is configurable or configured to determine the time period for the productivity to be assessed, measured, quantified, and/or processed for managing one or more users 10.

During the setup process, the time period processor 223 is configurable or configured to select a productivity assessment time period, wherein the assessment is performed on of the team's productivity during the selected assessment time period only. For example, the productivity assessment time period may be a day, work week, week, two (2) weeks, half month, month, quarter, half year, or year. The selected assessment time period is provided, sent, or otherwise made available to the one or more elements in the system 100 including the metric generators 222, and/or one or more productivity processors 230, as described in the present disclosure.

### The Productivity Processor (e.g., Productivity Processor 230).

As illustrated in at least FIG. 2 and FIG. 4, the main processor 200 includes and/or communicates with one or more productivity processors (e.g., productivity processor 230). The productivity processor 230 is configurable or configured to perform one or more of a plurality of functions, operations, actions, methods, and/or processes, including, but not limited to, identifying one or more elements of the system 100.

For example, the productivity processor 230 is also configurable or configured to search for, identify, select, compile, generate, transform, process, assess, and/or otherwise receive one or more productivity values, information relating to productivity, information relating to selected positive set of metrics, selected negative set of metrics, etc. from the main interface 210. The productivity processor 230 is also configurable or configured to search for, identify, select, compile, generate, transform, process, assess, and/or otherwise receive the team information from the setup processor 220. Alternatively and in addition, the productivity processor 230 may also be configurable or configured to communicate with the system 100 and/or the other elements of the system 100 including the user information database 30 and/or the productivity management subsystem 40 to receive one or more input. To perform the actions, functions, processes, and/or methods described above and in the present disclosure, example embodiments of the productivity processor 230 include one or more of the following elements.

As illustrated in FIG. 4, the productivity processor 230 includes one or more productivity value processors (e.g., productivity value processor 231), one or more uniformity processors (e.g., uniformity processor 232). The productivity processor 230 includes one or more centroid generation processors (e.g., centroid generation processor 233). The productivity processor 230 includes one or more productivity score processors (e.g., productivity score processor 234). The productivity processor 230 also includes one or more productivity recommendation processors (e.g., productivity recommendation processor 235). The elements of the productivity processor 230 will now be further described with reference to the accompanying figures.

### The Productivity Value Processors (e.g., Productivity Value Processor 231).

As illustrated in at least FIG. 4, the main processor 200 includes and/or communicates with one or more productivity value processors (e.g., productivity value processor 231). The productivity value processor 231 is configurable or configured to perform one or more of a plurality of functions, operations, actions, methods, and/or processes, including, but not limited to, identifying one or more elements of the system 100.

For example, the productivity value processor 231 is configurable or configured to generate a result (e.g., productivity value) for each of the metrics in the positive set of metrics and/or each metrics in the negative set of metrics. The productivity value of the selected positive set of metrics and the selected negative set of metrics may be generated, assessed and/or quantified using one or more tools and/or applications to achieve a productivity value for each metrics. For example, one or more SDLC tools may be used such as, but not limited to, Enterprise JIRA, Bitbucket, Jenkins, SonarQube, or the like. Alternatively or in addition, the metrics generator 222 may also be configurable or configured to communicate with the productivity management subsystem 40 to retrieve, obtain, determine, calculate, and/or manage the one or more productivity metrics and/or productivity metric values. Alternatively or in addition, the productivity value for each selected metrics may also be generated or obtained from one or more external sources, databases, and/or assessment tools.

The productivity values for each metric in the positive set of metrics includes at least one, but not limited to, a quantity of story points delivered by the team and/or quantity of user stories delivered 620, a quantity of story points delivered by the team relative to a quantity of story points committed by the team 602, a quantity of software code pushed by the team within normal working hours 604, a quantity of software code pushed by the team within normal working hours relative to a quantity of software code committed by the team, a quantity of product change requests by the team 606, and/or a team velocity or quantity of work that a team can accomplish 608. The productivity values for each metric in the negative set of metric includes at least one, but not limited to, a quantity of software bugs detected 610, a cycle time or time to market 612, a quantity of production incidents 614, a quantity of job failures 616, and/or code bug diversity and/or density over a selected number of programming files.

In an example embodiment, the productivity value processor 231 is configurable or configured to obtain or determine, for the selected or specified productivity assessment time period, a measured productivity value for each metric in a positive set of metrics. For example, the percentage of code pushed within office hours 604 would be 80% if the total code committed is 1,000 and the total code pushed within working hours is 800. For example, a velocity or quantity of work accomplished 608 may be calculated based on the total number of story points delivered within a specified duration, not necessarily the same duration as the productivity assessment period. In yet another example, a cycle time 612 may refer to the total business days or working hours spent on a specific task or issue (e.g., time taken to deliver all story points and perform regression testing, etc.).

In an example embodiment, the productivity value processor 231 is configurable or configured to obtain or determine, for the selected or specified productivity assessment time period, a measured productivity value for each metric in a negative set of metrics. For example, lead time may refer to the total business days or working hours between the time a task or project is requested to the time it is delivered (e.g., response time to a customer request, which may be a fresh assignment or addition of a feature, etc.). For example, the number of software bugs 610 may be the absolute bug count. Alternatively, software bugs 610 may be categorized into 3 categories: blocker, critical, and major, and a numerical value may be derived from the absolute number of bugs in each category where each category carries its own numerical weight (e.g., 3 blocker bugs×1.5 (the blocker value)+2 critical bugs*1 (the critical value)+1 major bug*0.8 (the major value)). For example, the number of production incidents 614 may be the absolute production incident count. Alternatively, production incidents 614 may be categorized into 4 categories of severity, such as from Level 1 to Level 4 where Level 1 has the highest impact and Level 4 has the lowest impact on production or operation stability, and a numerical value may be derived from the absolute number of production incidents in each category where each category carries its own numerical weight. Examples of categories of severity of production incidents may include certain online services being down (Level 1), a missed submission of regulatory reporting (Level 2), batch failures impacting downstream jobs that are recoverable within 24 hours (Level 3), and technical issues such as reaching disk capacity or almost full CPU utilisation, which may impact certain business processes (Level 4). For example, code bug density over a selected number of programming files may be based on the bugs found over a selected number of programming files (e.g., 1,000 programming files), weighted according to categories of bugs (e.g., blocker), and in relation to the number of file changes (e.g., 1037) (e.g., adding up the blocker value, the critical value, and major value to derive a bug diversity score, multiplying the bug diversity score by the selected number of programming files, then dividing that value by the number of file changes. The resultant value may be used as the value for bug density over a selected number of programming files).

Once a productivity value is determined for each metric selected, the productivity value processor 231 may store, share, and/or report the results (e.g., productivity value) of the metric assessment to the system 100, to the main processor 200, to the productivity processor 230, and/or to the one or more elements of the system 100 and/or the main processor 200. The generated or determined productivity value for each metric may also be stored in the productivity management subsystem 40 for future reference or use.

### The Uniformity Processors (e.g., Uniformity Processor 232)

As illustrated in FIG. 4, an example embodiment of the productivity processor 230 includes one or more uniformity processors (e.g., uniformity processor 232). The uniformity processor 231 is configurable or configured to perform a uniformity process on the generated productivity values for each metric in the positive set of metrics and each metric in the negative set of metrics during the productivity assessment process. The uniformity processor 231 is configurable or configured to discard outlier positive maximum values, outlier positive minimum values outlier positive negative values, and outlier negative minimum values.

As each metric of the positive set of metrics and the negative set of metrics has different quantity units and/or measurement units and are measured on different units/scales, the uniformity process is performed to normalize or transform the quantity units or measurement units of each metrics into a comparable and unitless score or units and/or a common scale (e.g., a metric score, a positive metric score, a negative metric score, etc.).

To perform this action, the uniformity processor 232 is configurable or configured to select a positive maximum value for each metric in the positive set of metrics and a positive minimum value for each metric in the positive set of metrics. Further, the uniformity processor 232 is configurable or configured to select a negative maximum value for each metric in the negative set of metrics and a negative minimum value for each metric in the negative set of metrics. Both the maximum values and the minimum values for each of the metrics in the positive set of metrics and each of the metrics in the negative set of metrics are determined from within a time period for productivity assessment, selected or specified during the setup process.

For example, the uniformity processor 232 selects a positive maximum value and a positive minimum value for each metric in the positive set of metrics during the selected or specified productivity assessment time period. The uniformity processor 232 obtains all the values recorded for the metric for measuring story points delivered 620, the metric for measuring user stories delivered, the metric for measuring story points delivered relative to story points committed 602, the metric for measuring software code pushed within normal working hours 604, the metric for measuring a quantity of software code pushed by the team within normal working hours relative to a quantity of software code committed, the metric for measuring product change requests 606, and/or the metric for measuring a team velocity or quantity of work that can be accomplished 608. For each metric (e.g., story points delivered), the maximum value and the minimum value from the values recorded for story points delivered during the selected or specified productivity assessment time period is determined. Similar determination process for a maximum value and a minimum value is also performed for each metrics in the negative set of metrics. Examples of negative metrics include, but not limited to, a metric for measuring a quantity of software bugs detected 610, a metric for measuring a cycle time or time to market 612, a metric for measuring a quantity of production incidents 614, a metric for measuring a quantity of job failures 616, and/or a metric for measuring code bug diversity and/or density over a selected number of programming files.

The uniformity processor 232 is further configurable or configured to generate a positive metric score for each of the metrics in the positive set of metrics and to generate a negative metric score for each of the metrics in the negative set of metrics. The uniformity processor 232 is further configurable or configured to generate a metric score for each of the metrics in the positive set of metrics and for each of the metrics in the negative set of metrics.

For the metrics in the positive set of metrics, a positive metric score is generated for each positive metrics, based on the ratio of obtained productivity value and the selected positive maximum value for the said metric. The positive metric score is generated by dividing the productivity value for each metric in the positive set of metrics with the selected maximum value for each metric in the positive set of metrics. A scaling factor is subsequently applied to normalize or transform the quantity units or measurement units of each metrics into a comparable and unitless score or units and/or a common score (e.g., positive metric score). The selected scaling factor may be a number or the like, to provide uniformity to each of the metrics in the positive set of metrics.

For the metrics in the negative set of metrics, a negative metric score is generated for each negative metrics, based on the ratio of obtained productivity value and the selected negative maximum value for the said metric. The negative metric score is generated by dividing the productivity values for each metric in the negative set of metrics with the selected negative value for each metric in the negative set of metrics. Similarly, a scaling factor is subsequently applied to normalize or transform the quantity units or measurement units of each metrics into a comparable and unitless score or units and/or a common score (e.g., negative metric score). The selected scaling factor may be a number or the like, to provide uniformity to each of the metrics in the negative set of metrics.

The uniformity processor 232 is configurable or configured to communicate the results or output (e.g., metric score, positive metric score, and negative metric score) to one or more centroid generation processors 233 as described in the present disclosure.

### The Centroid Generation Processors (e.g., Centroid Generation Processor 233).

As illustrated in FIG. 4, an example embodiment of the productivity processor 230 includes one or more centroid generation processors (e.g., centroid generation processor 233). The centroid generation processor 233 is configurable or configured to perform a centroid generation process to generate a representation of one or more productivity scores. Specifically, the centroid generation processor 233 is configurable or configured to generate a representation of one or more productivity scores spanning multiple productivity assessment periods and/or to identify one or more trends for recommendations to improve productivity.

To perform the above actions, the centroid generation processor 233 is configurable or configured to generate plots using the one or more positive metric scores, generated for each metric in the positive set of metrics, on a radar chart (also known as spider charts, polar charts, web charts, star plots, etc.) (see FIGS. 6-11 as an example). The centroid generation processor 233 is also configurable or configured to generate plots using the one or more negative metric scores, generated for each metric in the negative set of metrics, on a radar chart (see FIGS. 6-11 as an example). A resultant shape is generated by connecting all the plotted positive metric scores and the plotted negative metric scores, and a centroid value for the resultant shape is plotted. The centroid generation processor 233 is configurable or configured to generate one or more centroid shapes (e.g., first centroid shape, second centroid shape, third centroid shape, etc.).

For example, the centroid generation processor 233 determines an overall centroid value 701 based on a first resultant shape (see, for example, FIG. 7). The centroid generation processor 233 plots each of the positive metric scores generated for each metric in the positive set of metrics and each of the generated negative metric score for each metric in the negative set of metrics. All the plotted metric scores 703 are connected to generate a first resultant shape. An overall centroid value 701 for the first resultant shape is plotted and is a centroid for the first resultant shape (see, for example, FIG. 7).

In yet another example, the centroid generation processor 233 determines a maximum centroid value 801 based on a second resultant shape (see, for example, FIG. 8). The maximum centroid value 801 represents a positive or best centroid value. The centroid generation processor 233 plots each of the positive maximum values generated for each metric in the positive set of metrics and each of the negative minimum values generated for each metric in the negative set of metrics. All the plotted positive maximum values and the negative minimum values are connected to generate a second resultant shape. A maximum centroid value 801 for the second resultant shape is plotted and is a centroid for the second resultant shape (see, for example, FIG. 8).

In yet another example, the centroid generation processor 233 determines a minimum centroid value 901 based on a third resultant shape (see, for example, FIG. 9). The minimum centroid value 901 represents a negative or worst centroid value. The centroid generation processor 233 plots each of the positive minimum values generated for each metric in the positive set of metrics and each of the negative maximum values generated for each metric in the negative set of metrics. All the plotted positive minimum values and the negative maximum values are connected to generate a third resultant shape. A maximum centroid value 901 for the third resultant shape is plotted and is a centroid for the third resultant shape (see, for example, FIG. 9).

The centroid generation processor 233 is configurable or configured to communicate the results or output generated or obtained (e.g., centroid values, overall centroid value, maximum centroid value, minimum centroid value, etc.) to one or more productivity score processors 234 as described in the present disclosure.

### The Productivity Score Processors (e.g., Productivity Score Processor 234).

As illustrated in FIG. 4, an example embodiment of the productivity score processor 230 includes one or more productivity score processors (e.g., productivity score processor 234). The productivity score processor 234 is configurable or configured to generate one or more productivity scores for a user 10.

The productivity score for the one or more users 10 may be generated, by the productivity processor 234 based on a distance between the overall centroid value 701 of the first resultant shape and the maximum centroid value 801 for the second resultant shape (see, for example, distance “a” in FIG. 10). The productivity score may also be generated based on a distance between the maximum centroid value 801 for the second resultant shape and the minimum centroid value 901 for the third resultant shape (see, for example, distance “b” in FIG. 10). Further, the productivity score may also be generated based on one or more distances from the overall centroid value 701 of the first resultant shape and the minimum centroid value for the third resultant shape 901 (see, for example, distance “c” in FIG. 10).

The productivity score processor 234 may generate one or more productivity score using a productivity scaling number, or the like. For example, the productivity scaling number may be a unitless score, digit, number, unit and/or a common scale (e.g., a value of 1). The productivity score may be generated by subtracting the productivity scaling number from a number obtained by dividing a first distance (e.g., distance “a”) with a second distance (e.g., distance “b”); and/or subtracting the productivity scaling number from a number obtained by dividing a third distance (e.g., distance “c”) with the second distance (e.g., distance “b”); and/or subtracting the productivity scaling number from a number obtained by dividing the second distance (e.g., distance “b”) with the first distance (e.g., distance “a”); and/or subtracting the productivity scaling number from a number obtained by dividing the second distance (e.g., distance “b”) with the third distance (e.g., distance “c”); and/or subtracting the productivity scaling number from a number obtained by dividing the first distance (e.g., distance “a”) with the third distance (e.g., distance “c”); and/or subtracting the productivity scaling number from a number obtained by dividing the third distance (e.g., distance “c”) with the first distance (e.g., distance “a”). Alternatively or in addition, the one or more productivity scores may also be generated by dividing the third distance with the first distance, dividing the third distance with the second distance, dividing the second distance with the first distance, dividing the second distance with the third distance, dividing the first distance with the third distance, and/or dividing the third distance with the first distance.

The productivity score processor 234 is configurable or configured to communicate the results or output generated or obtained (e.g., productivity scores) to one or more productivity recommendation processors 234 as described in the present disclosure.

### The Productivity Recommendation Processors (e.g., Productivity Recommendation Processor 235).

As illustrated in FIG. 4 an example embodiment of the productivity recommendation processor 230 includes one or more productivity recommendation processors (e.g., productivity recommendation processor 235). The productivity recommendation processor 235 is configurable or configured to generate one or more recommendations in improving the productivity of a user 10. The productivity recommendation processor 235 generates one or more recommendations by performing calculations based on the distances determined by the productivity score processor 234.

For each metric in the positive set of metrics, the productivity recommendation processor 235 may generate one or more recommendations on improving the productivity of the user 10 by forming a first line between the overall centroid value 701 and the maximum centroid value 801. The recommendations on improving the productivity of the user 10 may also be generated by forming a second line between the overall centroid value 701 and a positive maximum value for the metric. Further, the recommendations on improving the productivity of the user 10 may be generated by identifying a first angle formed between the first and second lines. Please see FIG. 11 as an example.

As for each metric in the negative set of metrics, the productivity recommendation processor 235 may be configured or configurable to generate one or more recommendations on improving the productivity of the user 10 by forming a third line between the overall centroid value 701 and the minimum centroid value 901. The recommendations on improving the productivity of the user 10 may also be generated by forming a fourth line between the overall centroid value 701 and a negative minimum value for the metric. Further, the recommendations on improving the productivity of the user 10 may also be generated by identifying a second angle formed between the third and fourth lines.

Recommendations to improve productivity include, but are not limited to, specific productivity metrics which need to be increased in the next productivity assessment period (e.g., more total story points delivered), specific productivity metrics which should stay the same in the next productivity assessment period (e.g., number of bugs), and/or specific productivity metrics should need to be decreased in the next productivity assessment period (e.g., percentage of code committed after working hours).

In an example embodiment, the productivity recommendation processor 235 may generate such recommendations to improve productivity based on, for each positive metric, forming a first line between the overall centroid value 701 and the maximum centroid value 801, forming a second line between the overall centroid value 701 and the positive maximum value for the metric, and identifying a first angle formed between the first and second lines (see, for example, FIG. 11). The productivity recommendation processor 235 is then configurable or configured to calculate the cosine of the first angle to provide an indication of how much improvement in productivity is required.

In an example embodiment, such recommendations to improve productivity are generated based on, for each negative metric, forming a third line between the overall centroid value 701 and the minimum centroid value 901, forming a fourth line between the overall centroid value 701 and the negative minimum value for the metric, and identifying a second angle formed between the third and fourth lines. The productivity recommendation processor 235 is then configurable or configured to calculate the cosine of the second angle to provide an indication of how much improvement in productivity is required.

Once the productivity recommendation processor 235 has performed the above for each metric, including identifying a first and second angle and calculating the cosine of each of the first and second angles, the productivity recommendation processor 330 is configurable or configured to perform a prioritization process to determine which metric(s) to prioritize for recommending improvement. The prioritization process involves determining, for each positive metric, a prioritization weight using the following calculation:

$$prioritisation {weight}_{metric} = cosθ \cdot ( positive maximum centroid {value}_{metric} - overall centroid {value}_{metric} )$$

where θ=the first angle.

Once the productivity recommendation processor 235 has performed the above for each metric, including identifying a first and second angle and calculating the cosine of each of the first and second angles, the recommendation generator 330 is configurable or configured to perform a prioritization process to determine which metric(s) to prioritize for recommending improvement. The prioritization process involves determining, for each positive metric, a prioritization weight using the following calculation:

$$prioritisation {weight}_{metric} = cosθ \cdot ( negative minimum centroid value - overall centroid {value}_{metric} )$$

where θ=the second angle.

In an example embodiment, the larger the prioritization weight, the more prioritized the metric should be, and a positive or negative prioritization weight indicates whether the metric should be maximized or minimized.

For example, a productivity recommendation may be as follows:
i. Increase the value of the following metrics in order of priority:
   1. Total story points delivered
   2. Change requests
   3. Number of codes committed
   4. Percentage of story points delivered
ii. Decrease the value of the following metrics in order of priority:
   1. Number of incidents
   2. Percentage of code committed after working hours
   3. Number of bugs
   4. Time to market

Alternatively or in addition, the productivity recommendation processor 235 may generate recommendations based on the trends observed in the radar charts and/or plotted charts. Alternatively or in addition, the productivity score processor 234 may also generate recommendations by performing a comparison between productivity scores with historical productivity scores. Alternatively or in addition, the productivity recommendation generator may also generate recommendations based on the performance and/or productivity values of each of the metrics.

### Example Embodiments of a Method for Managing Productivity (e.g., Method 500).

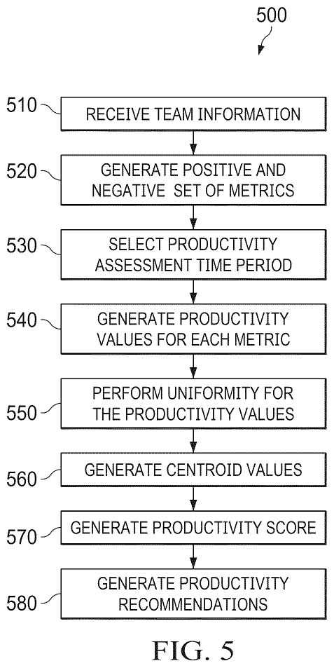

FIG. 5 illustrates an example embodiment of a method (e.g., method 500) for managing productivity 500 includes managing of one or more users, individuals, and/or teams 10 by the system 100. One or more actions of method 500 may be performed by one or more elements of the system 100 as described in the present disclosure.

In an example embodiment, the method 500 includes receiving and/or identifying one or more team information (e.g., action 510) for the team 10. The team information may include, but not limited to, personal data of a user (e.g., name, job position, identity, etc.), team information (e.g., team name, number of members in a team, size, position of each member, experience level of each member, experience of each member in working together in the team, hierarchy, etc.), one or more roles assigned to the team, one or more responsibilities assigned to the team, productivity assessment information of the team (e.g., types of metrics, specific metrics, metrics determination, productivity assessment requirements, productivity assessment periods, etc.), historical information (e.g., historical productivity information, historical metrics determinations, historical productivity assessment period, productivity value for each metric, historical productivity score, historical recommendations on improving productivity in the future, etc.).

The method 500 includes generating one or more metrics (e.g., action 520). For example, the metrics to be generated may include a positive set of metrics and a negative set of metrics, depending on the specifics in the request and/or command received, or productivity assessment to be performed. When generating the metrics for the assessment, each of the positive set of metrics is selected based on the negative set of metrics and each metric of the negative set of metrics is selected based on the positive set of metrics. Each of the metrics in the positive set of metrics is related to at least one or the metric in the negative set of metrics. Each metric in the positive set of metrics is also complementary to at least one of the metrics in the negative set of metrics. Examples of positive metrics include, but not limited to, a metric for measuring story points delivered 620, a metric for measuring user stories delivered, a metric for measuring story points delivered relative to story points committed 602, a metric for measuring software code pushed within normal working hours 604, a metric for measuring a quantity of software code pushed by the team within normal working hours relative to a quantity of software code committed, a metric for measuring product change requests 606, and/or a metric for measuring a team velocity or quantity of work that can be accomplished 608. Examples of negative metrics include, but not limited to, a metric for measuring a quantity of software bugs detected 610, a metric for measuring a cycle time or time to market 612, a metric for measuring a quantity of production incidents 614, a metric for measuring a quantity of job failures 616, and/or a metric for measuring code bug diversity and/or density over a selected number of programming files.

The method 500 further includes selecting one or more productivity assessment time period (e.g., action 530). In an example, the method 530 includes selecting a productivity assessment time period, wherein the assessment is performed on the team's productivity during the selected assessment time period only. The productivity assessment time period may be a day, work week, week, two (2) weeks, half month, month, quarter, half year, or year.

The method 500 further includes generating one or more productivity values for each of the metrics (e.g., action 540). The method 540 generates the productivity values for each selected metrics in the positive set of metrics and the negative set of metrics for the productivity assessment. The productivity values may also be generated, assessed and/or quantified using from one or more tools and/or applications for managing productivity (or performance) of a user 10. The productivity values may be generated from one or more tools and/or applications, but not limited to, productivity measurement tools, software development lifecycle (SDLC) tools, software management tools, tracking tools, tools for quantifying productivity, tools for quantifying work performance, etc. Alternatively or in addition, the method 540 may include retrieving and/or generating the productivity values for each metrics from one or more productivity management subsystems 40 as described in the present disclosure. Alternatively or in addition, the method 540 may include retrieving or obtaining the productivity values for each metrics from an external source, database and/or assessment tools.

The productivity values for each metric in the positive set of metrics includes at least one, but not limited to, a quantity of story points delivered by the team and/or quantity of user stories delivered 620, a quantity of story points delivered by the team relative to a quantity of story points committed by the team 602, a quantity of software code pushed by the team within normal working hours 604, a quantity of software code pushed by the team within normal working hours relative to a quantity of software code committed by the team, a quantity of product change requests by the team 606, and/or a team velocity or quantity of work that a team can accomplish 608. The productivity values for each metric in the negative set of metric includes at least one, but not limited to, a quantity of software bugs detected 610, a cycle time or time to market 612, a quantity of production incidents 614, a quantity of job failures 616, and/or code bug diversity and/or density over a selected number of programming files.

In another example embodiment, the method 500 includes performing uniformity for the productivity values (e.g., action 550). The method 550 includes performing a uniformity process on the generated productivity values for each metrics in the positive set of metrics and each metrics in the negative set of metrics during the productivity assessment process. The method 550 is to discard outlier positive maximum values, outlier positive minimum values outlier positive negative values, and outlier negative minimum values.

Each metrics of the positive set of metrics and the negative set of metrics has different quantity units and/or measurement units and are measured on different units/scales. The method 550 is performed to normalize or transform the quantity units or measurement units of each metrics into a comparable and unitless score or units and/or a common scale (e.g., a metric score, a positive metric score, a negative metric score, etc.). The method 550 includes selecting a positive maximum value for each metric in the positive set of metrics and a positive minimum value for each metric in the positive set of metrics. The method 550 further includes selecting a negative maximum value for each metric in the negative set of metrics and a negative minimum value for each metric in the negative set of metrics. Both the maximum values and the minimum values for each of the metrics in the positive set of metrics and each of the metrics in the negative set of metrics are determined from within a time period that is selected for productivity assessment.

In an example embodiment, the method 550 further includes, when performing uniformity for the productivity values, generating a positive metric score for each of the metrics in the positive set of metrics and to generate a negative metric score for each of the metrics in the negative set of metrics. For the metrics in the positive set of metrics, a positive metric score is generated for each positive metrics, based on the ratio of obtained productivity value and the selected positive maximum value for the said metric. The positive metric score is generated by dividing the productivity value for each metric in the positive set of metrics with the selected maximum value for each metric in the positive set of metrics. A scaling factor is subsequently applied to normalize or transform the quantity units or measurement units of each metrics into a comparable and unitless score or units and/or a common score (e.g., positive metric score). The selected scaling factor may be a number or the like, to provide uniformity to each of the metrics in the positive set of metrics. For the metrics in the negative set of metrics, a negative metric score is generated for each negative metrics, based on the ratio of obtained productivity value and the selected negative maximum value for the said metric. The negative metric score is generated by dividing the productivity values for each metric in the negative set of metrics with the selected negative value for each metric in the negative set of metrics. Similarly, a scaling factor is subsequently applied to normalize or transform the quantity units or measurement units of each metrics into a comparable and unitless score or units and/or a common score (e.g., negative metric score). The selected scaling factor may be a number or the like, to provide uniformity to each of the metrics in the negative set of metrics.

The method 500 further includes generating one or more centroid values (e.g., action 560). The method 560 includes generating a representation of one or more productivity scores spanning multiple productivity assessment periods and/or to identify one or more trends for recommendations to improve productivity. The method 560 generates plots using the one or more positive metric scores, generated for each metric in the positive set of metrics, on a radar chart (also known as spider charts, polar charts, web charts, star plots, etc.). The method 560 further includes generating plots using the one or more negative metric scores, generated for each metric in the negative set of metrics, on a radar chart. A resultant shape is generated by connecting all the plotted positive metric scores and the plotted negative metric scores, and a centroid value for the resultant shape is plotted (see, for example, FIG. 7). The method 560 also includes generating one or more centroid shapes (e.g., first centroid shape, second centroid shape, third centroid shape, etc.).

For example, the method 560 determines an overall centroid value 701 based on a first resultant shape (see, for example, FIG. 7). The method 560 plots each of the positive metric scores generated for each metric in the positive set of metrics and each of the generated negative metric score for each metric in the negative set of metrics. All the plotted metric scores are connected to generate a first resultant shape. An overall centroid value 701 for the first resultant shape is plotted and is a centroid for the first resultant shape (see, for example, FIG. 7). In yet another example, the method 560 determines a maximum centroid value 801 based on a second resultant shape (see, for example, FIG. 8). The maximum centroid value 801 represents a positive or best centroid value. The method 560 further plots each of the positive maximum values generated for each metric in the positive set of metrics and each of the negative minimum values generated for each metric in the negative set of metrics. All the plotted positive maximum values and the negative minimum values are connected to generate a second resultant shape. A maximum centroid value 801 for the second resultant shape is plotted and is a centroid for the second resultant shape (see, for example, FIG. 8). In yet another example, the method 560 determines a minimum centroid value 901 based on a third resultant shape (see FIG. 9). The minimum centroid value 901 represents a negative or worst centroid value. The method 560 plots each of the positive minimum values generated for each metric in the positive set of metrics and each of the negative maximum values generated for each metric in the negative set of metrics. All the plotted positive minimum values and the negative maximum values are connected to generate a third resultant shape. A minimum centroid value 801 for the third resultant shape is plotted and is a centroid for the third resultant shape (see FIG. 9).

The method 500 includes generating one or more productivity scores (e.g., action 570). The method 570 generates one or more productivity scores. The productivity score for the one or more users 10 may be generated based on a distance from the overall centroid value 701 of the first resultant shape and the maximum centroid value 801 for the second resultant shape (see, for example, distance “a” in FIG. 10). The productivity score may also be generated based on and one or more distances from the maximum centroid value 801 for the second resultant shape and the minimum centroid value 901 for the third resultant shape (see, for example, distance “b” in FIG. 10). Further, the productivity score may also be generated based on one or more distances from the overall centroid value 701 of the first resultant shape and the minimum centroid value 901 for the third resultant shape (see, for example, distance “c” in FIG. 10).

The method 570 may generate one or more productivity score using a productivity scaling number, or the like. For example, the productivity scaling number may be a unitless score, digit, number, unit and/or a common scale (e.g., a value of 1). The productivity score may be generated by subtracting the productivity scaling number from a number obtained by dividing a first distance (e.g., distance “a”) with a second distance (e.g., distance “b”); and/or subtracting the productivity scaling number from a number obtained by dividing a third distance (e.g., distance “c”) with the second distance (e.g., distance “b”); and/or subtracting the productivity scaling number from a number obtained by dividing the second distance (e.g., distance “b”) with the first distance (e.g., distance “a”); and/or subtracting the productivity scaling number from a number obtained by dividing the second distance (e.g., distance “b”) with the third distance (e.g., distance “c”); and/or subtracting the productivity scaling number from a number obtained by dividing the first distance (e.g., distance “a”) with the third distance (e.g., distance “c”); and/or subtracting the productivity scaling number from a number obtained by dividing the third distance (e.g., distance “c”) with the first distance (e.g., distance “a”). Alternatively or in addition, the one or more productivity scores may also be generated by dividing the third distance with the first distance, dividing the third distance with the second distance, dividing the second distance with the first distance, dividing the second distance with the third distance, dividing the first distance with the third distance, and/or dividing the third distance with the first distance.

The method 500 may also include generating one or more recommendations (e.g., action 580) in improving the productivity of the user 10 based on productivity scores that are generated. The recommendations generated are based on the productivity assessment performed as described in the present disclosure and/or based on the one or more productivity scores. For each metric in the positive set of metrics, one or more recommendations on improving the productivity of the user 10 may be generated, by forming a first line between the overall centroid value 701 and the maximum centroid value 801. The recommendations on improving the productivity of the user 10 may be generated by forming a second line between the overall centroid value 701 and a positive maximum value for the metric. Further, the recommendations on improving the productivity of the user 10 may also be generated by identifying a first angle formed between the first and second lines (see, for example, FIG. 11). As for each metric in the negative set of metrics, the method 580 generates one or more recommendations on improving the productivity of the team 10 by forming a third line between the overall centroid value 701 and the minimum centroid value 901. The recommendations on improving the productivity of the user 10 may be generated by forming a fourth line between the overall centroid value 701 and a negative minimum value for the metric. Further, the recommendations on improving the productivity of the user 10 may also be generated by identifying a second angle formed between the third and fourth lines. The method 580 calculates the cosine of the second angle to provide an indication of how much improvement in productivity is required.

It is to be understood that, in some embodiments, the setup process, the productivity assessment process and the recommendations to improve productivity process may be combined together as one process, one, two or three of the processes may be further separated into two or more separate processes or sub-processes, or one, two or three of the processes may be combined with one or more other processes (e.g., one or more other productivity assessment processes) without departing from the teachings of the present disclosure.

It is to be understood that, in some example embodiments, the setup process 510 and the productivity assessment process 520 may be combined together as one process, one or both may be further separated into one or more separate processes or both of the processes may be combined with one or more other processes without departing from the teachings of the present disclosure.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Also, as referred to herein, a processor, device, computing device, telephone, phone, mobile device, server, generator, subsystem, and/or controller, may be any processor, computing device, and/or communication device, and may include a virtual machine, computer, node, instance, host, or machine in a networked computing environment. Also as referred to herein, a network or cloud may be or include a collection of machines connected by communication channels that facilitate communications between machines and allow for machines to share resources. Network may also refer to a communication medium between processes on the same machine. Also as referred to herein, a network element, node, or server may be a machine deployed to execute a program operating as a socket listener and may include software instances.

Various terms used herein have special meanings within the present technical field. Whether a particular term should be construed as such a “term of art” depends on the context in which that term is used. Such terms are to be construed in light of the context in which they are used in the present disclosure and as one of ordinary skill in the art would understand those terms in the disclosed context. The above definitions are not exclusive of other meanings that might be imparted to those terms based on the disclosed context.

Additionally, the section headings and topic headings herein are provided for consistency with the suggestions under various patent regulations and practice, or otherwise to provide organizational cues. These headings shall not limit or characterize the embodiments set out in any claims that may issue from this disclosure. For example, a description of a technology, or the like, in the “Background” shall not be construed as an admission that such technology is prior art to any example embodiments in this disclosure. Furthermore, any reference in this disclosure to an “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. A method for managing productivity of a team, the method comprising:
performing, by a processor, a setup process, the setup process including:
identifying, by the processor, team information, the team information being information pertaining to the team;
generating, by the processor, a positive set of metrics, the positive set of metrics including a first quantity of quantifiable productivity metrics, each metric in the positive set of metrics being a metric in which higher values represent better results, each metric in the positive set of metrics selected based on at least the team information;
generating, by the processor, a negative set of metrics, the negative set of metrics including a second quantity of quantifiable productivity metrics, each metric in the negative set of metrics being a metric in which lower values represent better results, each metric in the negative set of metrics selected based on at least the team information;
selecting, by the processor, a productivity assessment time period;
performing, by the processor, a productivity assessment process for the team, the productivity assessment process for the team including:
obtaining, for the team for the productivity assessment time period, a productivity value for each metric in the positive set of metrics;
obtaining, for the team for the productivity assessment time period, a productivity value for each metric in the negative set of metrics;
performing a uniformity process, the uniformity process including:
selecting, for the team, a positive maximum value for each metric in the positive set of metrics, the positive maximum value for each metric in the positive set of metrics being a maximum value for the metric;
selecting, for the team, a positive minimum value for each metric in the positive set of metrics, the positive minimum value for each metric in the positive set of metrics being a minimum value for the metric;
selecting, for the team, a negative maximum value for each metric in the negative set of metrics, the negative maximum value for each metric in the negative set of metrics being a maximum value for the metric;
selecting, for the team, a negative minimum value for each metric in the negative set of metrics, the negative minimum value for each metric in the negative set of metrics being a minimum value for the metric;
for each metric in the positive set of metrics, generating a positive metric score for the metric in the positive set of metrics, each positive metric score for the metric in the positive set of metrics generated based on the obtained productivity value for the metric in the positive set of metrics and the selected positive maximum value; and
for each metric in the negative set of metrics, generating a negative metric score for the metric in the negative set of metrics, each negative metric score for the metric in the negative set of metrics generated based on the obtained productivity value for the metric in the negative set of metrics and the selected negative maximum value;
performing a first centroid generation process, the first centroid generation process including:
plotting, on a radar chart for each metric in the positive set of metrics, the generated positive metric score for the metric in the positive set of metrics;
plotting, on the radar chart for each metric in the negative set of metrics, the generated negative metric score for the metric in the negative set of metrics;
generating, on the radar chart, a first resultant shape, the first resultant shape generated by connecting all generated positive metric scores plotted in the radar chart and all generated negative metric scores plotted in the radar chart;
plotting, on the radar chart, an overall centroid value for the first resultant shape, the overall centroid value for the first resultant shape being a centroid for the first resultant shape;
performing a second centroid generation process, the second centroid generation process including:
plotting, on the radar chart for each metric in the positive set of metrics, the selected positive maximum value for the metric in the positive set of metrics;
plotting, on the radar chart for each metric in the negative set of metrics, the selected negative minimum value for the metric in the negative set of metrics;
generating, on the radar chart, a second resultant shape, the second resultant shape generated by connecting all selected positive maximum values plotted in the radar chart and all selected negative minimum values plotted in the radar chart;
plotting, on the radar chart, a maximum centroid value for the second resultant shape, the maximum centroid value for the second resultant shape being a centroid for the second resultant shape;
performing a third centroid generation process, the third centroid generation process including:
plotting, on the radar chart for each metric in the positive set of metrics, the selected positive minimum value for the metric in the positive set of metrics;
plotting, on the radar chart for each metric in the negative set of metrics, the selected negative maximum value for the metric in the negative set of metrics;
generating, on the radar chart, a third resultant shape, the third resultant shape generated by connecting all selected positive minimum values plotted in the radar chart and all selected negative maximum values plotted in the radar chart;
plotting, on the radar chart, a minimum centroid value for the third resultant shape, the minimum centroid value for the third resultant shape being a centroid for the third resultant shape; and
generating a productivity score for the team, the productivity score generated based on at least:
a first distance, the first distance being a distance from the overall centroid value for the first resultant shape and the maximum centroid value for the second resultant shape; and
a second distance, the second distance being a distance from the maximum centroid value for the second resultant shape and the minimum centroid value for the third resultant shape.

2. The method of claim 1, wherein at least one of the following apply:
the team includes one or more members;
the team information includes at least one of the following information:
an identity of each member in the team;
historical productivity information of each member in the team;
roles of each member in the team;
responsibilities of each member in the team;
position and/or seniority of each member in the team;
number of members in the team;
experience level of each member of the team; and
experience of each member in working together in the team;
the first quantity of quantifiable productivity metrics is equal to the second quantity of quantifiable productivity metrics;
each metric in the positive set of metrics is further selected based on the negative set of metrics;
each metric in the negative set of metrics is further selected based on the positive set of metrics; and
the productivity assessment time period is a day, work week, week, 2 weeks, half month, month, quarter, half year, or year.

3. The method of claim 1, wherein at least one of the following apply:
each metric in the positive set of metrics and each metric in the negative set of metrics are selected in such a way that at least one of the metrics in the positive set of metrics is related to at least one of the metrics in the negative set of metrics; and
each metric in the positive set of metrics and each metric in the negative set of metrics are selected in such a way that at least one of the metrics in the positive set of metrics is complementary to at least one of the metrics in the negative set of metrics.

4. The method of claim 1, wherein the positive set of metrics includes at least one of the following:
a metric for measuring a quantity of story points delivered by the team and/or quantity of user stories delivered;
a metric for measuring a quantity of story points delivered by the team relative to a quantity of story points committed by the team;
a metric for measuring a quantity of software code pushed by the team within normal working hours;
a metric for measuring a quantity of software code pushed by the team within normal working hours relative to a quantity of software code committed by the team;
a metric for measuring a quantity of product change requests by the team; and
a metric for measuring a team velocity or quantity of work that a team can accomplish.

5. The method of claim 1, wherein the negative set of metrics includes at least one of the following:
a metric for measuring a quantity of software bugs detected;
a metric for measuring a cycle time or time to market;
a metric for measuring a quantity of production incidents;
a metric for measuring a quantity of job failures; and
a metric for measuring code bug diversity and/or density over a selected number of programming files.

6. The method of claim 1, wherein the productivity value for each metric in the positive set of metrics includes at least one of the following:
a quantity of story points delivered by the team and/or quantity of user stories delivered;
a quantity of story points delivered by the team relative to a quantity of story points committed by the team;
a quantity of software code pushed by the team within normal working hours;
a quantity of software code pushed by the team within normal working hours relative to a quantity of software code committed by the team;
a quantity of product change requests by the team; and
a team velocity or quantity of work that a team can accomplish.

7. The method of claim 1, wherein the productivity value for each metric in the negative set of metrics includes at least one of the following:
a quantity of software bugs detected;
a cycle time or time to market;
a quantity of production incidents;
a quantity of job failures; and
a value of code bug diversity and/or density over a selected number of programming files.

8. The method of claim 1, wherein at least one of the following apply:
the selecting of the positive maximum value for the team for each metric in the positive set of metrics includes selecting a maximum value from a time period spanning one or more productivity assessment time periods;
the selecting of the negative minimum value for the team for each metric in the negative set of metrics includes selecting a minimum value from a time period spanning one or more productivity assessment time periods;
the selecting of the positive minimum value for the team for each metric in the positive set of metrics includes selecting a minimum value from a time period spanning one or more productivity assessment time periods; and
the selecting of the negative maximum value for the team for each metric in the negative set of metrics includes selecting a maximum value from a time period spanning one or more productivity assessment time periods.

9. The method of claim 1, wherein at least one of the following apply:
each positive metric score for each metric in the positive set of metrics is determined by dividing the obtained productivity value for the metric in the positive set of metrics with the selected positive maximum value and applying a scaling factor; and
each negative metric score for each metric in the negative set of metrics is determined by dividing the obtained productivity value for the metric in the negative set of metrics with the selected negative maximum value and applying the scaling factor.

10. The method of claim 1, wherein
the productivity score is further generated based on a third distance, the third distance being a distance from the overall centroid value for the first resultant shape and the minimum centroid value for the third resultant shape.

11. The method of claim 1, wherein
the productivity score is generated by subtracting a productivity scaling number from a number obtained by dividing the first distance with the second distance.

12. The method of claim 10, wherein the productivity score is generated based on at least one of the following:
subtracting a productivity scaling number from a number obtained by dividing the first distance with the second distance;
subtracting the productivity scaling number from a number obtained by dividing the third distance with the second distance;
subtracting the productivity scaling number from a number obtained by dividing the second distance with the first distance;
subtracting the productivity scaling number from a number obtained by dividing the second distance with the third distance;
subtracting the productivity scaling number from a number obtained by dividing the first distance with the third distance;
dividing the third distance with the first distance;
dividing the third distance with the second distance;
dividing the second distance with the first distance;
dividing the second distance with the third distance;
dividing the first distance with the third distance; and
dividing the third distance with the first distance.

13. The method of claim 1, further comprising generating a recommendation to improve productivity of the team, the recommendation generated based on:
for each metric in the positive set of metrics:
forming a first line between the overall centroid value and the maximum centroid value;
forming a second line between the overall centroid value and a positive maximum value for the metric; and
identifying a first angle formed between the first and second lines; and
for each metric in the negative set of metrics:
forming a third line between the overall centroid value and the minimum centroid value;
forming a fourth line between the overall centroid value and a negative minimum value for the metric; and
identifying a second angle formed between the third and fourth lines.

14. A method for managing productivity of a team, the method comprising:
identifying, by a processor, a positive set of metrics, the positive set of metrics including a first quantity of quantifiable productivity metrics, each metric in the positive set of metrics being a metric in which higher values represent better results;
identifying, by the processor, a negative set of metrics, the negative set of metrics including a second quantity of quantifiable productivity metrics, each metric in the negative set of metrics being a metric in which lower values represent better results;
identifying, by the processor, a productivity assessment time period;
performing, by the processor, a productivity assessment process for the team, the productivity assessment process for the team including:
obtaining, for the team for the productivity assessment time period, a productivity value for each metric in the positive set of metrics;
obtaining, for the team for the productivity assessment time period, a productivity value for each metric in the negative set of metrics;
performing a uniformity process, the uniformity process including:
selecting, for the team, a positive maximum value for each metric in the positive set of metrics, the positive maximum value for each metric in the positive set of metrics being a maximum value for the metric;
selecting, for the team, a positive minimum value for each metric in the positive set of metrics, the positive minimum value for each metric in the positive set of metrics being a minimum value for the metric;
selecting, for the team, a negative maximum value for each metric in the negative set of metrics, the negative maximum value for each metric in the negative set of metrics being a maximum value for the metric;
selecting, for the team, a negative minimum value for each metric in the negative set of metrics, the negative minimum value for each metric in the negative set of metrics being a minimum value for the metric;
for each metric in the positive set of metrics, generating a positive metric score for the metric in the positive set of metrics, each positive metric score for the metric in the positive set of metrics determined based on the obtained productivity value for the metric in the positive set of metrics and the selected positive maximum value; and
for each metric in the negative set of metrics, generating a negative metric score for the metric in the negative set of metrics, each negative metric score for the metric in the negative set of metrics determined based on the obtained productivity value for the metric in the negative set of metrics and the selected negative maximum value;
performing a first centroid generation process, the first centroid generation process including:
plotting, on a chart for each metric in the positive set of metrics, the generated positive metric score for the metric in the positive set of metrics;
plotting, on the chart for each metric in the negative set of metrics, the generated negative metric score for the metric in the negative set of metrics;
generating, on the chart, a first resultant shape, the first resultant shape generated by connecting all generated positive metric scores plotted in the chart and all generated negative metric scores plotted in the chart;
plotting, on the chart, an overall centroid value for the first resultant shape, the overall centroid value for the first resultant shape being a centroid for the first resultant shape;
performing a second centroid generation process, the second centroid generation process including:
plotting, on the chart for each metric in the positive set of metrics, the selected positive maximum value for the metric in the positive set of metrics;
plotting, on the chart for each metric in the negative set of metrics, the selected negative minimum value for the metric in the negative set of metrics;
generating, on the chart, a second resultant shape, the second resultant shape generated by connecting all selected positive maximum values plotted in the chart and all selected negative minimum values plotted in the chart;
plotting, on the chart, a maximum centroid value for the second resultant shape, the maximum centroid value for the second resultant shape being a centroid for the second resultant shape; and
performing a third centroid generation process, the third centroid generation process including:
plotting, on the chart for each metric in the positive set of metrics, the selected positive minimum value for the metric in the positive set of metrics;
plotting, on the chart for each metric in the negative set of metrics, the selected negative maximum value for the metric in the negative set of metrics;
generating, on the chart, a third resultant shape, the third resultant shape generated by connecting all selected positive minimum values plotted in the chart and all selected negative maximum values plotted in the chart;
plotting, on the chart, a minimum centroid value for the third resultant shape, the minimum centroid value for the third resultant shape being a centroid for the third resultant shape.
generating a productivity score for the team, the productivity score generated based on at least the overall centroid value for the first resultant shape, the maximum centroid value for the second resultant shape, and the minimum centroid value for the third resultant shape.

15. The method of claim 14, wherein the productivity score for the team is generated based on the following:
a first distance, the first distance being a distance from the overall centroid value for the first resultant shape and the maximum centroid value for the second resultant shape; and
a second distance, the second distance being a distance from the maximum centroid value for the second resultant shape and the minimum centroid value for the third resultant shape.

16. The method of claim 14, wherein at least one of the following apply:
the first quantity of quantifiable productivity metrics is equal to the second quantity of quantifiable productivity metrics;
each metric in the positive set of metrics is selected based on at least one of the following: information pertaining to the team, and the negative set of metrics;
each metric in the negative set of metrics is selected based on at least one of the following: information pertaining to the team, and the positive set of metrics; and
the productivity assessment time period is a day, work week, week, 2 weeks, half month, month, quarter, half year, or year.

17. The method of claim 14, wherein at least one of the following apply:
each metric in the positive set of metrics and each metric in the negative set of metrics are selected in such a way that at least one of the metrics in the positive set of metrics is related to at least one of the metrics in the negative set of metrics; and
each metric in the positive set of metrics and each metric in the negative set of metrics are selected in such a way that at least one of the metrics in the positive set of metrics is complementary to at least one of the metrics in the negative set of metrics.

18. The method of claim 14, wherein the positive set of metrics includes at least one of the following:
a metric for measuring a quantity of story points delivered by the team and/or quantity of user stories delivered;
a metric for measuring a quantity of story points delivered by the team relative to a quantity of story points committed by the team;
a metric for measuring a quantity of software code pushed by the team within normal working hours;
a metric for measuring a quantity of software code pushed by the team within normal working hours relative to a quantity of software code committed by the team;
a metric for measuring a quantity of product change requests by the team; and
a metric for measuring a team velocity or quantity of work that a team can accomplish

19. The method of claim 14, wherein the negative set of metrics includes at least one of the following:
a metric for measuring a quantity of software bugs detected;
a metric for measuring a cycle time or time to market;
a metric for measuring a quantity of production incidents;
a metric for measuring a quantity of job failures; and
a metric for measuring code bug diversity and/or density over a selected number of programming files.

20. The method of claim 14, wherein the productivity value for each metric in the positive set of metrics includes at least one of the following:
a quantity of story points delivered by the team and/or quantity of user stories delivered;
a quantity of story points delivered by the team relative to a quantity of story points committed by the team;
a quantity of software code pushed by the team within normal working hours;
a quantity of software code pushed by the team within normal working hours relative to a quantity of software code committed by the team;
a quantity of product change requests by the team; and
a team velocity or quantity of work that a team can accomplish.

21. The method of claim 14, wherein the productivity value for each metric in the negative set of metrics includes at least one of the following:
a quantity of software bugs detected;
a cycle time or time to market;
a quantity of production incidents;
a quantity of job failures; and
a value of code bug diversity and/or density over a selected number of programming files.

22. The method of claim 14, wherein at least one of the following apply:
the selecting of the positive maximum value for the team for each metric in the positive set of metrics includes selecting a maximum value from a time period spanning one or more productivity assessment time periods;
the selecting of the negative minimum value for the team for each metric in the negative set of metrics includes selecting a minimum value from a time period spanning one or more productivity assessment time periods;
the selecting of the positive minimum value for the team for each metric in the positive set of metrics includes selecting a minimum value from a time period spanning one or more productivity assessment time periods; and
the selecting of the negative maximum value for the team for each metric in the negative set of metrics includes selecting a maximum value from a time period spanning one or more productivity assessment time periods.

23. The method of claim 14, wherein at least one of the following apply:
each positive metric score for each metric in the positive set of metrics is determined by dividing the obtained productivity value for the metric in the positive set of metrics with the selected positive maximum value and applying a scaling factor; and
each negative metric score for each metric in the negative set of metrics is determined by dividing the obtained productivity value for the metric in the negative set of metrics with the selected negative maximum value and applying the scaling factor.

24. The method of claim 15, wherein
the productivity score is further generated based on a third distance, the third distance being a distance from the overall centroid value for the first resultant shape and the minimum centroid value for the third resultant shape.

25. The method of claim 15, wherein
the productivity score is generated by subtracting a productivity scaling number from a number obtained by dividing the first distance with the second distance.

26. The method of claim 24, wherein the productivity score is generated based on at least one of the following:
subtracting a productivity scaling number from a number obtained by dividing the first distance with the second distance;
subtracting the productivity scaling number from a number obtained by dividing the third distance with the second distance;
subtracting the productivity scaling number from a number obtained by dividing the second distance with the first distance;
subtracting the productivity scaling number from a number obtained by dividing the second distance with the third distance;
subtracting the productivity scaling number from a number obtained by dividing the first distance with the third distance;
dividing the third distance with the first distance;
dividing the third distance with the second distance;
dividing the second distance with the first distance;
dividing the second distance with the third distance;
dividing the first distance with the third distance; and
dividing the third distance with the first distance.

27. The method of claim 14, further comprising generating a recommendation to improve productivity of the team, the recommendation generated based on:
for each metric in the positive set of metrics:
forming a first line between the overall centroid value and the maximum centroid value;
forming a second line between the overall centroid value and a positive maximum value for the metric; and
identifying a first angle formed between the first and second lines; and
for each metric in the negative set of metrics:
forming a third line between the overall centroid value and the minimum centroid value;
forming a fourth line between the overall centroid value and a negative minimum value for the metric; and
identifying a second angle formed between the third and fourth lines.

28. A method for managing productivity of a team, the method comprising:
identifying, by a processor, a positive set of metrics, the positive set of metrics including a first quantity of quantifiable productivity metrics, each metric in the positive set of metrics being a metric in which higher values represent better results, each metric in the positive set of metrics selected based on at least the team information;
identifying, by the processor, a negative set of metrics, the negative set of metrics including a second quantity of quantifiable productivity metrics, each metric in the negative set of metrics being a metric in which lower values represent better results, each metric in the negative set of metrics selected based on at least the team information;
performing, by the processor, a productivity assessment process for the team, the productivity assessment process for the team including:
receiving, for the team for a productivity assessment time period, a productivity value for each metric in the positive set of metrics;
receiving, for the team for the productivity assessment time period, a productivity value for each metric in the negative set of metrics;
performing a uniformity process, the uniformity process including:
selecting, for the team, a positive maximum value for each metric in the positive set of metrics, the positive maximum value for each metric in the positive set of metrics being a maximum value for the metric;
selecting, for the team, a positive minimum value for each metric in the positive set of metrics, the positive minimum value for each metric in the positive set of metrics being a minimum value for the metric;
selecting, for the team, a negative maximum value for each metric in the negative set of metrics, the negative maximum value for each metric in the negative set of metrics being a maximum value for the metric;
selecting, for the team, a negative minimum value for each metric in the negative set of metrics, the negative minimum value for each metric in the negative set of metrics being a minimum value for the metric;
for each metric in the positive set of metrics, generating a positive metric score for the metric in the positive set of metrics, each positive metric score for the metric in the positive set of metrics determined based on the obtained productivity value for the metric in the positive set of metrics and the selected positive maximum value; and
for each metric in the negative set of metrics, generating a negative metric score for the metric in the negative set of metrics, each negative metric score for the metric in the negative set of metrics determined based on the obtained productivity value for the metric in the negative set of metrics and the selected negative maximum value;
performing a first centroid generation process, the first centroid generation process including:
plotting, on a radar chart for each metric in the positive set of metrics, the generated positive metric score for the metric in the positive set of metrics;
plotting, on the radar chart for each metric in the negative set of metrics, the generated negative metric score for the metric in the negative set of metrics;
generating, on the radar chart, a first resultant shape, the first resultant shape generated by connecting all generated positive metric scores plotted in the radar chart and all generated negative metric scores plotted in the radar chart;
plotting, on the radar chart, an overall centroid value for the first resultant shape, the overall centroid value for the first resultant shape being a centroid for the first resultant shape;
identifying a maximum centroid value, the maximum centroid value being a centroid value for a second resultant shape, the second resultant shape being a shape formed by: plotting, on the radar chart for each metric in the positive set of metrics and negative set of metrics, the selected positive maximum value for the metric in the positive set of metrics and the selected negative minimum value for the metric in the negative set of metrics, respectively; and forming the second resultant shape based on the plotted positive maximum values and negative minimum values on the radar chart;
identifying a minimum centroid value, the minimum centroid value being a centroid value for a third resultant shape, the third resultant shape being a shape formed by: plotting, on the radar chart for each metric in the positive set of metrics and negative set of metrics, the selected positive minimum value for the metric in the positive set of metrics and the selected negative maximum value for the metric in the negative set of metrics, respectively; and forming the third resultant shape based on the plotted positive minimum values and negative maximum values on the radar chart; and
generating a productivity score for the team, the productivity score generated based on at least the overall centroid value for the first resultant shape, the maximum centroid value for the second resultant shape, and the minimum centroid value for the third resultant shape.

29. The method of claim 28, wherein the productivity score for the team is generated based on the following:
a first distance, the first distance being a distance from the overall centroid value for the first resultant shape and the maximum centroid value for the second resultant shape; and
a second distance, the second distance being a distance from the maximum centroid value for the second resultant shape and the minimum centroid value for the third resultant shape.

30. The method of claim 28, wherein at least one of the following apply:
the first quantity of quantifiable productivity metrics is equal to the second quantity of quantifiable productivity metrics;
each metric in the positive set of metrics is selected based on at least one of the following:
information pertaining to the team, and the negative set of metrics;
each metric in the negative set of metrics is selected based on at least one of the following:
information pertaining to the team, and the positive set of metrics; and
the productivity assessment time period is a day, work week, week, 2 weeks, half month, month, quarter, half year, or year.

31. The method of claim 28, wherein at least one of the following apply:
each metric in the positive set of metrics and each metric in the negative set of metrics are selected in such a way that at least one of the metrics in the positive set of metrics is related to at least one of the metrics in the negative set of metrics; and
each metric in the positive set of metrics and each metric in the negative set of metrics are selected in such a way that at least one of the metrics in the positive set of metrics is complementary to at least one of the metrics in the negative set of metrics.

32. The method of claim 28, wherein the positive set of metrics includes at least one of the following:
a metric for measuring a quantity of story points delivered by the team and/or quantity of user stories delivered;
a metric for measuring a quantity of story points delivered by the team relative to a quantity of story points committed by the team;
a metric for measuring a quantity of software code pushed by the team within normal working hours;
a metric for measuring a quantity of software code pushed by the team within normal working hours relative to a quantity of software code committed by the team;
a metric for measuring a quantity of product change requests by the team; and
a metric for measuring a team velocity or quantity of work that a team can accomplish.

33. The method of claim 28, wherein the negative set of metrics includes at least one of the following:
a metric for measuring a quantity of software bugs detected;
a metric for measuring a cycle time or time to market;
a metric for measuring a quantity of production incidents;
a metric for measuring a quantity of job failures; and
a metric for measuring code bug diversity and/or density over a selected number of programming files.

34. The method of claim 28, wherein the productivity value for each metric in the positive set of metrics includes at least one of the following:
a quantity of story points delivered by the team and/or quantity of user stories delivered;
a quantity of story points delivered by the team relative to a quantity of story points committed by the team;
a quantity of software code pushed by the team within normal working hours;
a quantity of software code pushed by the team within normal working hours relative to a quantity of software code committed by the team;
a quantity of product change requests by the team; and
a team velocity or quantity of work that a team can accomplish.

35. The method of claim 28, wherein the productivity value for each metric in the negative set of metrics includes at least one of the following:
a quantity of software bugs detected;
a cycle time or time to market;
a quantity of production incidents;
a quantity of job failures; and
a value of code bug diversity and/or density over a selected number of programming files.

36. The method of claim 28, wherein at least one of the following apply:
the selecting of the positive maximum value for the team for each metric in the positive set of metrics includes selecting a maximum value from a time period spanning one or more productivity assessment time periods;
the selecting of the negative minimum value for the team for each metric in the negative set of metrics includes selecting a minimum value from a time period spanning one or more productivity assessment time periods;
the selecting of the positive minimum value for the team for each metric in the positive set of metrics includes selecting a minimum value from a time period spanning one or more productivity assessment time periods; and
the selecting of the negative maximum value for the team for each metric in the negative set of metrics includes selecting a maximum value from a time period spanning one or more productivity assessment time periods.

37. The method of claim 28, wherein at least one of the following apply:
each positive metric score for each metric in the positive set of metrics is determined by dividing the obtained productivity value for the metric in the positive set of metrics with the selected positive maximum value and applying a scaling factor; and
each negative metric score for each metric in the negative set of metrics is determined by dividing the obtained productivity value for the metric in the negative set of metrics with the selected negative maximum value and applying the scaling factor.

38. The method of claim 29, wherein
the productivity score is further generated based on a third distance, the third distance being a distance from the overall centroid value for the first resultant shape and the minimum centroid value for the third resultant shape.

39. The method of claim 29, wherein
the productivity score is generated by subtracting a productivity scaling number from a number obtained by dividing the first distance with the second distance.

40. The method of claim 28, wherein the productivity score is generated based on at least one of the following:
subtracting a productivity scaling number from a number obtained by dividing the first distance with the second distance;
subtracting the productivity scaling number from a number obtained by dividing the third distance with the second distance;
subtracting the productivity scaling number from a number obtained by dividing the second distance with the first distance;
subtracting the productivity scaling number from a number obtained by dividing the second distance with the third distance;
subtracting the productivity scaling number from a number obtained by dividing the first distance with the third distance;
dividing the third distance with the first distance;
dividing the third distance with the second distance;
dividing the second distance with the first distance;
dividing the second distance with the third distance;
dividing the first distance with the third distance; and
dividing the third distance with the first distance.

41. The method of claim 28, further comprising generating a recommendation to improve productivity of the team, the recommendation generated based on:
for each metric in the positive set of metrics:
forming a first line between the overall centroid value and the maximum centroid value;
forming a second line between the overall centroid value and a positive maximum value for the metric; and
identifying a first angle formed between the first and second lines; and
for each metric in the negative set of metrics:
forming a third line between the overall centroid value and the minimum centroid value;
forming a fourth line between the overall centroid value and a negative minimum value for the metric; and
identifying a second angle formed between the third and fourth lines.

42. A method for managing productivity of a team, the method comprising:
performing, by a processor, a setup process, the setup process including:
identifying, by the processor, team information, the team information being information pertaining to the team, the team information including at least one of the following information:
an identity of each member in the team;
historical productivity information of each member in the team;
roles of each member in the team;
responsibilities of each member in the team;
position and/or seniority of each member in the team;
number of members in the team;
experience level of each member in the team; and
experience of each member in working together in the team;
generating, by the processor, a positive set of metrics, the positive set of metrics including a first quantity of quantifiable productivity metrics, each metric in the positive set of metrics being a metric in which higher values represent better results, each metric in the positive set of metrics selected based on at least the team information;
generating, by the processor, a negative set of metrics, the negative set of metrics including a second quantity of quantifiable productivity metrics, each metric in the negative set of metrics being a metric in which lower values represent better results, each metric in the negative set of metrics selected based on at least the team information and the positive set of metrics;
selecting, by the processor, a productivity assessment time period;
performing, by the processor, a productivity assessment process for the team, the productivity assessment process for the team including:
obtaining, for the team for the productivity assessment time period, a productivity value for each metric in the positive set of metrics;
obtaining, for the team for the productivity assessment time period, a productivity value for each metric in the negative set of metrics;
performing a uniformity process, the uniformity process including:
selecting, for the team, a positive maximum value for each metric in the positive set of metrics, the positive maximum value for each metric in the positive set of metrics being a maximum value for the metric, wherein the selecting of the positive maximum value for each metric in the positive set of metrics includes discarding outlier positive maximum values;
selecting, for the team, a positive minimum value for each metric in the positive set of metrics, the positive minimum value for each metric in the positive set of metrics being a minimum value for the metric, wherein the selecting of the positive minimum value for each metric in the positive set of metrics includes discarding outlier positive minimum values;
selecting, for the team, a negative maximum value for each metric in the negative set of metrics, the negative maximum value for each metric in the negative set of metrics being a maximum value for the metric, wherein the selecting of the negative maximum value for each metric in the negative set of metrics includes discarding outlier negative maximum values;
selecting, for the team, a negative minimum value for each metric in the negative set of metrics, the negative minimum value for each metric in the negative set of metrics being a minimum value for the metric, wherein the selecting of the negative minimum value for each metric in the negative set of metrics includes discarding outlier negative minimum values;
for each metric in the positive set of metrics, generating a positive metric score for the metric in the positive set of metrics, each positive metric score for the metric in the positive set of metrics determined based on a ratio of the obtained productivity value for the metric in the positive set of metrics and the selected positive maximum value; and
for each metric in the negative set of metrics, generating a negative metric score for the metric in the negative set of metrics, each negative metric score for the metric in the negative set of metrics determined based on a ratio of the obtained productivity value for the metric in the negative set of metrics and the selected negative maximum value;
performing a first centroid generation process, the first centroid generation process including:
plotting, on a radar chart for each metric in the positive set of metrics, the generated positive metric score for the metric in the positive set of metrics;
plotting, on the radar chart for each metric in the negative set of metrics, the generated negative metric score for the metric in the negative set of metrics;
generating, on the radar chart, a first resultant shape, the first resultant shape generated by connecting all generated positive metric scores plotted in the radar chart and all generated negative metric scores plotted in the radar chart;
plotting, on the radar chart, an overall centroid value for the first resultant shape, the overall centroid value for the first resultant shape being a centroid for the first resultant shape;
performing a second centroid generation process, the second centroid generation process including:
plotting, on the radar chart for each metric in the positive set of metrics, the selected positive maximum value for the metric in the positive set of metrics;
plotting, on the radar chart for each metric in the negative set of metrics, the selected negative minimum value for the metric in the negative set of metrics;
generating, on the radar chart, a second resultant shape, the second resultant shape generated by connecting all selected positive maximum values plotted in the radar chart and all selected negative minimum values plotted in the radar chart;
plotting, on the radar chart, a maximum centroid value for the second resultant shape, the maximum centroid value for the second resultant shape being a centroid for the second resultant shape;
performing a third centroid generation process, the third centroid generation process including:
plotting, on the radar chart for each metric in the positive set of metrics, the selected positive minimum value for the metric in the positive set of metrics;
plotting, on the radar chart for each metric in the negative set of metrics, the selected negative maximum value for the metric in the negative set of metrics;
generating, on the radar chart, a third resultant shape, the third resultant shape generated by connecting all selected positive minimum values plotted in the radar chart and all selected negative maximum values plotted in the radar chart;
plotting, on the radar chart, a minimum centroid value for the third resultant shape, the minimum centroid value for the third resultant shape being a centroid for the third resultant shape;
generating a productivity score for the team, the productivity score generated based on at least:
a first distance, the first distance being a distance from the overall centroid value for the first resultant shape and the maximum centroid value for the second resultant shape; and
a second distance, the second distance being a distance from the maximum centroid value for the second resultant shape and the minimum centroid value for the third resultant shape; and
generating a recommendation to improve productivity of the team, the recommendation generated based on:
for each metric in the positive set of metrics:
forming a first line between the overall centroid value and the maximum centroid value;
forming a second line between the overall centroid value and a positive maximum value for the metric; and
identifying a first angle formed between the first and second lines; and
for each metric in the negative set of metrics:
forming a third line between the overall centroid value and the minimum centroid value;
forming a fourth line between the overall centroid value and a negative minimum value for the metric; and
identifying a second angle formed between the third and fourth lines.
